(19) United States
(12) Patent Application Publication
(10) Pub. No.: US 2022/0197529 A1
(43) Pub. Date: Jun. 23, 2022

(54) SYSTEMS AND METHODS FOR SECURELY SHARING DATA IN A MULTI-PORT MEMORY STORAGE DEVICE

(71) Applicant: SEALING TECHNOLOGIES, INC., Columbia, MD (US)

(72) Inventors: Ed SEALING, Queenstown, MD (US); Andres GIRALDO, Columbia, MD (US); Brandon WHALEN, Columbia, MD (US)

(21) Appl. No.: 17/133,114

(22) Filed: Dec. 23, 2020

(51) Int. Cl. G06F 3/06; G06F 9/4401

(52) U.S. Cl. CPC G06F 3/0644; G06F 3/0607; G06F 9/4411; G06F 3/0646; G06F 3/0613

(57) ABSTRACT

Example implementations include a method, a device, and a system for providing, by a device via a first port communicatively coupled with a first memory controller, read and write access to a shared namespace of a plurality of namespaces. A non-volatile memory storage of the device comprises the plurality of namespaces, the first memory controller being communicatively coupled with a non-volatile memory storage comprising the plurality of namespaces. The method further includes providing, by the device via a second port communicatively coupled with a second memory controller, read-only access to the shared namespace, the second memory controller being communicatively coupled with the non-volatile memory storage.

### TECHNICAL FIELD

The present invention relates generally to data sharing, and, in particular embodiments, to a system and method for securely sharing data in a multi-port memory storage device.

### BACKGROUND

Many individuals and enterprises (e.g., corporations, partnerships, governments, academic institutions, other organizations, etc.) increasingly rely on the gathering and analyzing of extremely large amounts of data (e.g., terabytes, petabytes, exabytes, or above) to fulfill their information technology needs. Typically, the gathering and/or analyzing of these extremely large amounts of data necessitates that the data be transferred across a domain or security boundary. For example, one network entity may have one assigned sensitivity level (e.g., unclassified) and the other network entity may have a different assigned sensitivity level (e.g., classified). In another example, one network entity may be part of the network of one enterprise and the other network entity may be part of the network of a different enterprise. In yet another example, one network entity may be located at an unprotected portion of a network (e.g., outside of a firewall, in a demilitarized zone (DMZ), or the like) and the other network entity may be located in an internal enterprise network (i.e., behind a firewall). In each of these examples, the security of each domain or network needs to be protected to prevent unauthorized access to the respective networks.

Some conventional cross-domain techniques may utilize a data (or transfer) diode to establish a one-way communication path across the domain boundary. The data diode may allow data to be transferred (or copied) from one domain or security level to the other domain while preventing unauthorized access to either domain. However, because this technique copies the data from one domain to the other domain, storage size requirements may be significantly higher than the original size of the data. Additionally, latency may be introduced due to the time required to copy the data across the domain, and complexity may be added to keep the two copies synchronized with each other.

Another conventional cross-domain technique may utilize a multi-port storage device that may allow multiple computer systems to access shared data stored therein. While this technique avoids copying the data, conventional multi-port storage devices do not prevent unauthorized access to the shared data or to the respective networks of the multiple computer systems. Thus, there exists a need for further improvements in data sharing technology. Improvements are presented herein. These improvements may also be applicable to other multi-access technologies and the standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method comprising providing, by a device via a first port communicatively coupled with a first memory controller, read and write access to a shared namespace of a plurality of namespaces. The first memory controller is communicatively coupled with a non-volatile memory storage comprising the plurality of namespaces. The method further includes providing, by the device via a second port communicatively coupled with a second memory controller, read-only access to the shared namespace. The second memory controller is communicatively coupled with the non-volatile memory storage.

Another example implementation includes a device comprising a first port communicatively coupled with a first memory controller. The first port is configured to provide read and write access to a shared namespace of a plurality of namespaces. The first memory controller is communicatively coupled with a non-volatile memory storage comprising the plurality of namespaces. The device further comprises a second port communicatively coupled with a second memory controller. The second port is configured to provide read-only access to the shared namespace. The second memory controller is communicatively coupled with the non-volatile memory storage.

Another example implementation includes a system comprising a first client subsystem, a second client subsystem, a non-volatile memory storage, and a device. The non-volatile memory storage comprises a plurality of namespaces. The device comprises a first port and a second port. The first port is communicatively coupled with a first memory controller and with the first client subsystem. The first port is configured to provide, to the first client subsystem, read and write access to a shared namespace of the plurality of namespaces. The first memory controller is communicatively coupled with the non-volatile memory storage. The second port is communicatively coupled with a second memory controller and with the second client subsystem. The second port is configured to provide, to the second client subsystem, read-only access to the shared namespace. The second memory controller is communicatively coupled with the non-volatile memory storage.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The aspects believed to be characteristic of implementations of the present disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as further aspects and advances thereof, will be best understood by reference to the following detailed description of illustrative implementations of the disclosure when read in conjunction with the accompanying drawings.

FIG. 1 is a diagram illustrating an example of a dual-port data processing system, in accordance with various aspects of the present disclosure.

FIG. 2 is a diagram illustrating an example of a multi-port data processing system, in accordance with various aspects of the present disclosure.

FIG. 3 is a diagram illustrating another example of a dual-port data processing system, in accordance with various aspects of the present disclosure.

FIG. 4 is a diagram illustrating another example of a multi-port data processing system, in accordance with various aspects of the present disclosure.

FIG. 5A is a diagram illustrating an example of a dual-port memory storage device, in accordance with various aspects of the present disclosure.

FIG. 5B is a diagram illustrating an example of a first multi-port memory storage device that may be used in accordance with one or more aspects of the present disclosure.

FIG. 5C is a diagram illustrating an example of a second multi-port memory storage device that may be used in accordance with one or more aspects of the present disclosure.

FIG. 6 is a diagram illustrating an example of a computer system for use in conjunction with various aspects of the present disclosure.

FIG. 7 is a diagram illustrating an example apparatus for controlling access to a memory storage in accordance with various aspects of the present disclosure.

FIG. 8 is a flowchart of a method of memory storage access to be performed by an example command filtering device in accordance with various aspects of the present disclosure.

FIG. 9 is a flowchart of first additional or optional steps for a method of memory storage access to be performed by an example command filtering device in accordance with various aspects of the present disclosure.

FIG. 10 is a flowchart of second additional or optional steps for a method of memory storage access to be performed by an example command filtering device in accordance with various aspects of the present disclosure.

FIG. 11 is a flowchart of third additional or optional steps for a method of memory storage access to be performed by an example command filtering device in accordance with various aspects of the present disclosure.

FIG. 12 is a flowchart of fourth additional or optional steps for a method of memory storage access to be performed by an example command filtering device in accordance with various aspects of the present disclosure.

FIG. 13 is a flowchart of fifth additional or optional steps for a method of memory storage access to be performed by an example command filtering device in accordance with various aspects of the present disclosure.

FIG. 14 is a flowchart of sixth additional or optional steps for a method of memory storage access to be performed by an example command filtering device in accordance with various aspects of the present disclosure.

### DETAILED DESCRIPTION OF ILLUSTRATIVE EMBODIMENTS

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is indicated by the appended claims rather than by this detailed description. All changes that come within the meaning and range of equivalency of the claims are to be embraced within their scope.

Reference throughout this specification to features, advantages, or similar language does not imply that all of the features and advantages that may be realized with the present solution should be or are in any single embodiment of the present solution. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages, and characteristics of the present solution may be combined in any suitable manner in one or more embodiments. One skilled in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

As used in this document, the singular form “a,” “an,” and “the” include plural references unless the context clearly dictates otherwise. Unless defined otherwise, all technical and scientific terms used herein have the same meanings as commonly understood by one of ordinary skill in the art.

As a general introduction to the subject matter described in more detail below, aspects described herein are directed towards systems, devices, and methods for providing a client with read and write access to a shared portion of the memory storage and providing another client with read-only access to the shared portion of the memory storage. Aspects described herein may be used to provide a client with secure read-only access to data that has been written or stored by another client in a designated shared memory storage area.

For example, a memory storage device may provide, to two or more clients, access to a shared portion of the memory storage controlled by the memory storage device. The clients may share amongst themselves only the data stored in the shared portion of the memory storage device. The clients may access the memory storage device via respective ports of the memory storage device. Each port of the memory storage device may be controlled by a corresponding controller of the memory storage device. As such, clients may securely share data stored in the shared portion of the memory storage device while preventing unauthorized access to other portions of the memory storage device or to their respective client networks. For example, a client belonging to a domain may securely share only designated data with another client belonging to another domain. In some aspects, the memory storage device may allow clients to share data across a security boundary. For example, a client of a network with an assigned sensitivity level (e.g., unclassified) may securely share data with another client of another network with another sensitivity level (e.g., classified), while simultaneously preventing unauthorized access to other portions of the memory storage device or to their respective networks.

Aspects presented herein provide for enforcing read-only access to the shared portion of the memory storage device to a first client while enforcing read-write access to the shared portion of the memory storage device to a second client. Enforcement of the read-only access to the first client and the read-write access to the second client may be implemented using hardware, software, or a combination thereof. For example, the memory storage device may be configured to prevent tampering with the read-write configuration and the read-only configuration of the memory storage device. Thus, aspects presented herein may allow clients to securely share data comprised by a memory storage device without a need to copy or transfer data from one device to another device or from one location to another location of a same device. As a result, memory storage capacity requirements may be reduced as data may not need to be duplicated. Furthermore, data transfer speeds may be positively impacted and usability of memory storage systems may be improved.

Several aspects of memory storage systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that can be accessed by a computer.

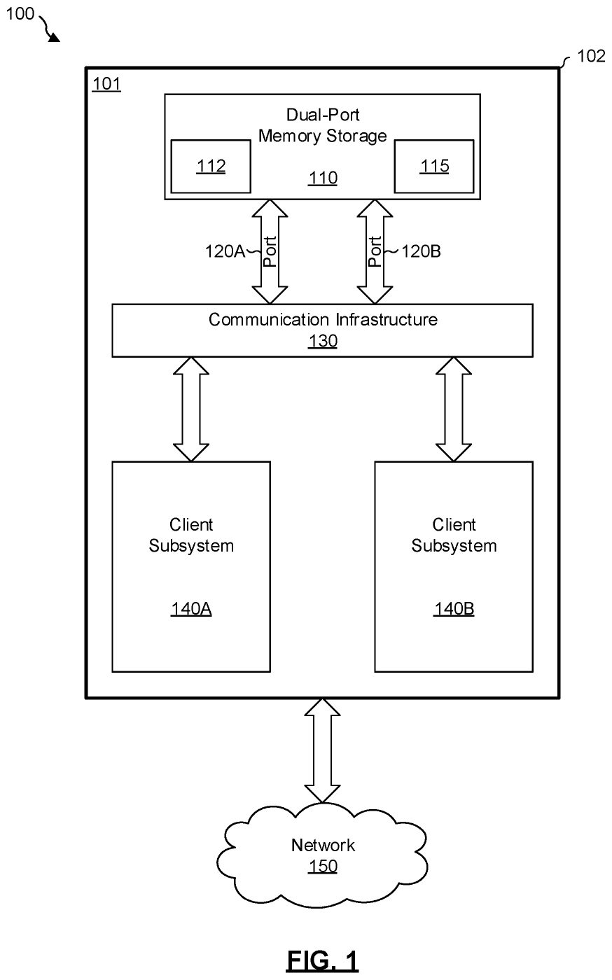

FIG. 1 illustrates one example of a system architecture and a data processing system that may be used to implement one or more illustrative aspects described herein in a standalone and/or networked environment. In the illustrated embodiment, the data processing system 101 may include a chassis 102 that houses the components of the data processing system 101, only some of which are illustrated below.

The data processing system 101 may comprise two client subsystems 140A-140B (generally referred to herein as “client subsystem(s) 140”), a dual-port memory storage 110, and a communication infrastructure 130. The data processing system 101 may be configured to provide to one client subsystem 140 read-write access to a shared portion of the dual-port memory storage 110 and to provide to the other client subsystem 140 read-only access to the shared portion of the dual-port memory storage 110.

The chassis 102 may house the components comprised by the data processing system 101 (i.e., the client subsystems 140, the dual-port memory storage 110, and the communication infrastructure 130). Alternatively or additionally, the chassis 102 may comprise multiple enclosures that separately house the components of the data processing system 101. In some aspects, the chassis 102 may house additional components such as power supplies, fans, and the like, which have been omitted for the sake of simplicity.

The client subsystem 140A may be communicatively coupled with a port 120A of the dual-port memory storage 110 via the communication infrastructure 130. The client subsystem 140B may be communicatively coupled with a port 120B of the dual-port memory storage 110 via the communication infrastructure 130. In some aspects, the client subsystem 140A may be communicatively coupled with the port 120B of the dual-port memory storage 110 and the client subsystem 140B may be communicatively coupled with the port 120A of the dual-port memory storage 110. That is, each client subsystem 140 may be communicatively coupled with the dual-port memory storage 110 via a corresponding port 120 (e.g., 120A, 120B) of the dual-port memory storage 110.

The dual-port memory storage 110 may comprise a command filter component 112 configured to provide read-only access to a shared portion of the dual-port memory storage 110 to a first client subsystem 140 while providing read-write access to the shared portion of the dual-port memory storage 110 to a second client subsystem 140. For example, the command filter component 112 may be configured in a read-only configuration and/or a read-write configuration. The read-only configuration of the command filter component 112 may comprise accepting or permitting a client subsystem 140 to read data from the shared portion of the dual-port memory storage 110 while preventing or rejecting write data requests from the client subsystem 140 to the shared portion of the dual-port memory storage 110. The read-write configuration of the command filter component 112 may comprise accepting or permitting a client subsystem 140 to read and/or write data to the shared portion of the of the dual-port memory storage 110. In some aspects, the command filter component 112 may be configured to filter memory access commands according to the read-only access configuration and the read-write access configuration. That is, the command filter component 112 may cause memory access commands to be processed, rejected, or ignored based at least on the read-only access configuration or the read-write access configuration. Alternatively or additionally, the command filter component 112 may be configured to resist tampering or modification of the read-only access configuration and the read-write access configuration of the dual-port memory storage 110.

The dual-port memory storage 110 may comprise a non-volatile memory 115 that may be accessed by the client subsystems 140 via the ports 120A-120B (generally referred to herein as “port(s) 120”). The non-volatile memory 115 may comprise a non-volatile semiconductor memory, such as a solid state drive (SSD), a NAND flash memory, a magneto-resistive random access memory (MRAM), a phase change random access memory (PRAM), resistive random access memory (Re-RAM), or ferroelectric random access memory (FeRAM). In some aspects, the non-volatile memory 115 may comprise a magnetic memory or a semiconductor memory of a three-dimensional structure. In some aspects, the non-volatile memory 115 may comprise multiple memory storage devices (e.g., a disk array with multiple SSDs) that may be configured to be accessed at different redundant array of independent disks (RAID) levels, such as RAID0, RAID1, RAID5, or the like.

The non-volatile memory 115 may be logically divided into portions, areas, or namespaces (not shown). A namespace may refer to an addressable subset of the non-volatile memory 115 that may be formatted into logical blocks for block access. A namespace may constitute a portion of the non-volatile memory 115, the entirety of the non-volatile memory 115, or a multi-device memory space spanning multiple non-volatile memories 115 and/or multiple dual-port memory storage 110. Each namespace may have a corresponding namespace identifier (ID) that uniquely identifies the namespace and may be used by the dual-port memory storage 110 to reference a particular namespace. In some aspects, the client subsystem 140 may access a particular memory location of the non-volatile memory 115 by specifying a namespace (e.g., using a unique ID associated with the namespace) and an associated logical address for the requested block or blocks.

The non-volatile memory 115 may comprise at least one shared namespace that may be accessible from ports 120 of the dual-port memory storage 110. In some aspects, the non-volatile memory 115 may further comprise other namespaces that may be accessed by only one port 120 of the dual-port memory storage 110. For example, the non-volatile memory 115 may comprise a first namespace that may only be accessed by port 120A. That is, the first namespace may not be accessible via port 120B of the dual-port memory storage 110. Alternatively or additionally, the non-volatile memory 115 may comprise a second namespace that may only be accessed by port 120B. That is, the second namespace may not be accessible via port 120A of the dual-port memory storage 110.

The dual-port memory storage 110 may receive memory access commands that act on a particular namespace or a range of namespaces. The memory access commands may comprise commands for retrieving data stored in a namespace of the non-volatile memory 115. For example, the memory access commands may comprise, among others, a “read” command, a “compare” command, and a “verify” command. The “read” command may read data and/or metadata from a specified block or blocks in the non-volatile memory 115. The “compare” command may compare specified data with the contents of a specified block or blocks in the non-volatile memory 115. The “verify” command may verify integrity of data and/or metadata stored in a specified block or blocks in the non-volatile memory 115.

Alternatively or additionally, the memory access commands may comprise write commands for modifying data stored in a namespace of the non-volatile memory 115. For example, the memory access commands may comprise, among others, a “write” command that may write data and/or metadata to a specified block or blocks in the non-volatile memory 115, a “flush” command that may write content of a volatile write cache (not shown) to a specified block or blocks in the non-volatile memory 115, and a “write zeroes” command that may set a range of logical blocks to a zero value.

In some aspects, the memory access commands may comprise commands for administration, configuration, and/or management of the dual-port memory storage 110 and/or of the data contained by the non-volatile memory 115. For example, the memory access commands may comprise, among others, a “firmware commit” command, a “firmware image download” command, and a “format” command. The “firmware commit” command may modify a firmware image of the dual-port memory storage 110. The “firmware image download” command may download all or a portion of a firmware image for subsequent update to the dual-port memory storage 110. The “format” command may perform a low-level format of the non-volatile memory 115.

The memory access commands may be received from the client subsystems 140 via the ports 120 of the dual-port memory storage 110. The dual-port memory storage 110 may comply with one or more Non-Volatile Memory Express (NVMe) standards. For example, the client subsystems 140 may transmit memory access commands to the dual-port memory storage 110 that comply with a NVMe standard. Alternatively or additionally, the dual-port memory storage 110 may comply with one or more other memory storage standards. In some aspects, the dual-port memory storage 110 may comply with a Peripheral Component Interconnect (PCI) standard, a PCI Express (PCIe) standard, or a NVMe over Fabrics standard.

The ports 120A-120B may comprise a connector (not shown) compliant with a storage communication protocol (e.g., NVMe, PCI, PCIe) such as an Small Form Factor 8369 (SFF-8369) connector, an Ethernet connector (e.g., RJ45), a hard disk drive connector, a connector type used to connect computer peripherals, a connector used to connect network storage, and/or any suitable kind of connector.

A read-only port 120 (e.g., 120A or 120B) of the dual-port memory storage 110 may be configured to only provide read-only access to the shared namespace of the non-volatile memory 115. That is, a client subsystem 140 accessing the dual-port memory storage 110 via the read-only port 120 may only read data stored in the shared namespace. For example, the command filter component 112 may filter out write commands for the shared namespace received from the client subsystem 140 via the read-only port 120. Alternatively or additionally, the command filter component 112 may cause the dual-port memory storage 110 to reject or ignore the write commands for the shared namespace received from the client subsystem 140 via the read-only port 120. Furthermore, the command filter component 112 may accept or pass-through read commands for the shared namespace received from the client subsystem 140 on the read-only port 120. Alternatively or additionally, the command filter component 112 may cause the dual-port memory storage 110 to process the read commands for the shared namespace received from the client subsystem 140 via the read-only port 120.

In some aspects, a read-write port 120 (e.g., 120B or 120A) of the dual-port memory storage 110 may be configured to only provide read-write access to the shared namespace of the non-volatile memory 115. That is, a client subsystem 140 (e.g., 140B or 140A) may read data stored in the shared namespace and write data to the shared namespace. For example, the command filter component 112 may accept or pass-through memory access commands for the shared namespace received from the client subsystem 140 via the read-write port 120. Alternatively or additionally, the command filter component 112 may cause the dual-port memory storage 110 to process the memory access commands for the shared namespace received from the client subsystem 140 via the read-write port 120. For example, a client subsystem 140 that is communicatively coupled with the dual-port memory storage 110 via the read-only port 120 may read data stored in the shared namespace, but may be prevented from writing data to the shared namespace. In another example, another client subsystem 140 that is communicatively coupled with the dual-port memory storage 110 via the read-write port 120 may read data from the shared namespace and write data to the shared namespace.

Alternatively or additionally, a client subsystem 140 may read and write data in a private namespace associated with the port 120. A private namespace may be a namespace that may only be accessed via a corresponding port 120. For example, the dual-port memory storage 110 may provide read-write access to a first private namespace associated with the read-only port 120 to the client subsystem 140 that is communicatively coupled with the read-only port 120. Alternatively or additionally, the dual-port memory storage 110 may provide read-write access to a second private namespace associated with the read-write port 120 to the client subsystem 140 that is communicatively coupled with the read-write port 120.

In some aspects, the configuration of the read-only port 120 of the dual-port memory storage 110 may be implemented using hardware, software, or a combination thereof. Alternatively or additionally, the configuration of the read-write port 120 of the dual-port memory storage 110 may be implemented using hardware, software, or a combination thereof. For example, the dual-port memory storage 110 may comprise one or more FPGAs or application specific integrated circuits (ASICs) (not shown) configured to implement the configuration of the read-only port 120 and/or the configuration of the read-write port 120. The one or more FPGAs or ASICs may be further configured to implement the command filter component 112. That is, the one or more FPGAs or ASICs may be configured to pass-through and process read commands, received via the read-only port 120, for data stored in the namespaces. The one or more FPGAs or ASICs may be further configured to filter out, reject, or ignore write commands, received via the read-only port 120, for data stored in the shared namespace. The one or more FPGAs or ASICs may be further configured to pass-through and process read and write commands, received via the read-write port 120, for data stored in the namespaces.

The one or more FPGAs or ASICs may be further configured to resist tampering with the configuration of the one or more FPGAs or ASICs. That is, the one or more FPGAs or ASICs may deny or prevent additions, deletions, or modifications to the configuration and/or instructions of the one or more FPGAs or ASICs. For example, the one or more FPGAs or ASICs may filter out or reject commands for administration, configuration, and/or management of the dual-port memory storage 110 and/or of the data contained by the non-volatile memory 115 (e.g., “firmware commit” command, “firmware image download” command, “format” command). In other aspects, the one or more FPGAs or ASICs may continuously monitor the configuration and/or instructions of the one or more FPGAs or ASICs to detect single or multiple-bit changes. Thus, the dual-port memory storage 110, as described herein, may allow clients to securely share data comprised by the dual-port memory storage 110 without a need to copy or transfer data from one namespace to another namespace of the dual-port memory storage 110 or from the dual-port memory storage 110 to another memory storage device.

Referring to FIG. 1, the client subsystems 140 may be any type of known computer, server, or data processing device. For example, the client subsystem may comprise a processor, a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), or the like. Alternatively or additionally, and as illustrated in greater detail below, the client subsystems 140 may be special-purpose computing devices configured to perform specific functions. Each client subsystem 140 may be communicatively coupled with a corresponding port 120 of the dual-port memory storage 110 via the communication infrastructure 130. In some aspects, the client subsystems 140 may be communicatively coupled with a network 150, such as the Internet. Other networks may also or alternatively be used, including private intranets, corporate networks, local area networks (LAN), metropolitan area networks (MAN), wireless networks, personal networks (PAN), and the like.

The client subsystems 140 may be configured to execute instructions for accessing data stored in a shared namespace of the dual-port memory storage 110. For example, the client subsystems 140 may be configured to send read and write commands to the dual-port memory storage 110 via a corresponding port 120 of the dual-port memory storage 110. In some aspects, the client subsystem 140A may be configured to read and write data to the shared namespace of the dual-port memory storage 110, and the client subsystem 140B may be configured to only read data from the shared namespace of the dual-port memory storage 110. For example, the client subsystem 140B may be configured to read data from the shared namespace that may have been written to the namespace by the client subsystem 140A. In other aspects, the client subsystem 140A may be configured to only read data from the shared namespace of the dual-port memory storage 110, and the client subsystem 140B may be configured to read and write data to the shared namespace of the dual-port memory storage 110. For example, the client subsystem 140A may be configured to read data from the shared namespace that may have been written to the namespace by the client subsystem 140B.

In some aspects, the client subsystem 140 may be configured to store data in the shared namespace of the dual-port memory storage 110. The stored data may comprise one or more of audio data, image data, video data, raw data, control data, program data, or the like. The stored data may have been generated by the client subsystem 140. In other aspects, the client subsystem 140 may be configured to gather or collect data from the network 150 and to store the collected data in the shared namespace of the dual-port memory storage 110. For example, the client subsystem 140 may be configured to execute instructions (e.g., programs, applications) that may generate, gather, collect, or store data. Alternatively or additionally, the client subsystem 140 may be further configured to process the gathered or collected data prior to storing the processed data in the shared namespace of the dual-port memory storage 110. Data processing of the gathered or collected data may also be performed by another computing device (not shown) in communication with the client subsystem 140. In other aspects, the client subsystem 140 may be configured to read and store additional data in a private namespace corresponding to the port 120 of the dual-port memory storage 110 that is communicatively coupled with the client subsystem 140.

Alternatively or additionally, the client subsystem 140A may belong to one domain and the client subsystem 140B may belong to another domain. For example, the client subsystem 140A may be part of an unclassified network and the client subsystem 140B may be part of a classified network. For another example, the client subsystem 140A may be part of one enterprise network and the client subsystem 140B may be part of another enterprise network. In yet another example, the client subsystem 140A may be communicatively coupled with an internal enterprise network (e.g., behind an enterprise firewall) and the subsystem 140B may be communicatively coupled with an external network (e.g., outside of the enterprise network).

The client subsystem 140 may comprise a combination of physical machines, and retain separate virtual or logical addresses, or may reside on separate physical machines. FIG. 1 illustrates just one example of a system architecture that may be used, and those of skill in the art will appreciate that the specific system architecture and the data processing system used may vary, and are secondary to the functionality that they provide, as further described herein. For example, a particular client subsystem 140 may comprise a single physical machine or may comprise a combination of multiple virtual machines.

The communication infrastructure 130 may comprise a printed circuit board on which various elements of the data processing system 101 (e.g., dual-port memory storage 110, client subsystem 140) are attached. For example, the communication infrastructure 130 may comprise metal traces that communicatively couple the various elements as described herein. In some aspects, the communication infrastructure 130 may comprise connectors (not shown) compliant with a storage communication protocol (e.g., NVMe, PCI, PCIe) such as SFF-8369 connectors, Ethernet connectors (e.g., RJ45), hard disk drive connectors, and/or any suitable kind of connectors. For example, the communication infrastructure 130 may comprise a PCIe switch configured to connect a client subsystem 140 with a corresponding port 120. Alternatively or additionally, the communication infrastructure 130 may comprise twisted pair wires, coaxial cable, optical fiber, radio waves or other communication media for connecting the various elements of the data processing system 101.

The client subsystems 140 and other elements (not shown) may be communicatively coupled with the network 150 via the communication infrastructure 130 using twisted pair wires, coaxial cable, optical fiber, radio waves or other communication media. Alternatively or additionally, the client subsystems 140 and other elements may be directly connected to the network 150. The wired or wireless network connectivity, may include, but not be limited to one or more universal serial bus (USB) connections, wireless fidelity (Wi-Fi) coupling, Bluetooth or Bluetooth Low Energy (BLE) coupling, Ethernet connection, cable connection, digital subscriber line (DSL) connection, cellular coupling (e.g., 3G, LTE/4G or 5G), or other suitable coupling or couplings.

The term “network” as used herein and depicted in the drawings may refer not only to systems in which remote storage devices are coupled together via one or more communication paths, but may also refer to stand-alone devices that may be coupled, from time to time, to such systems that have storage capability. Consequently, the term “network” includes not only a “physical network” but also a “content network,” which is comprised of the data—attributable to a single entity—which resides across all physical networks.

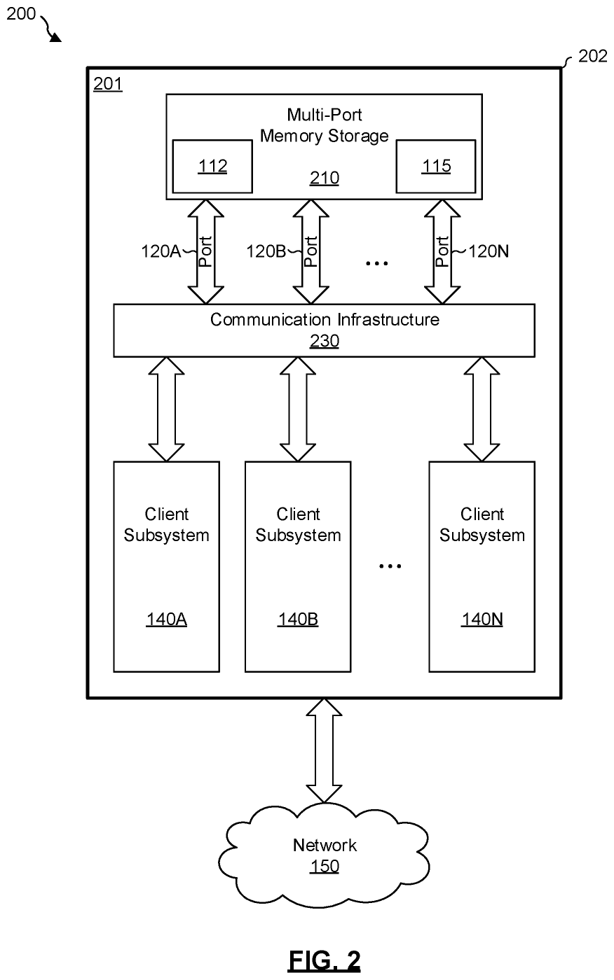

While FIG. 1 illustrates the data processing system 101 with the dual-port memory storage 110 coupled with the two client subsystems 140, one of skill in the art in possession of the present disclosure will recognize that memory storage devices with different numbers of ports (e.g., four or more ports) that are coupled with a corresponding quantity of client subsystems may benefit from the teachings of the present disclosure and will fall within its scope as well. For example, FIG. 2 illustrates another example of a system architecture and a data processing system that may be used to implement one or more illustrative aspects described herein in a standalone and/or networked environment. In the illustrated embodiment, the data processing system 201 may include a chassis 202 that houses the components of the data processing system 201, only some of which are illustrated below. The architecture of the system depicted in FIG. 2 is similar in many respects to the system architecture 100 described above with reference to FIG. 1 and may include additional features not mentioned above.

The chassis 202 may house N client subsystems 140A-140N (generally referred to herein as “client subsystem(s) 140”), a multi-port memory storage 210, and a communication infrastructure 230, where N is an integer greater than 2 (i.e., 3, 4, 5, . . . ). Each client subsystem of the N client subsystems 140 may be communicatively coupled with a corresponding port 120A-120N (generally referred to herein as “port(s) 120”) of the multi-port memory storage 210 via a communication infrastructure 230. For example, the client subsystem 140A may be communicatively coupled with a port 120A of the multi-port memory storage 210 via the communication infrastructure 230, the client subsystem 140B may be communicatively coupled with a port 120B of the multi-port memory storage 210 via the communication infrastructure 230, and the client subsystem 140N may be communicatively coupled with a port 120N of the multi-port memory storage 210 via the communication infrastructure 230. That is, each client subsystem 140 may be communicatively coupled with the multi-port memory storage 210 via a corresponding port 120 of the multi-port memory storage 210. Alternatively or additionally, a client subsystem 140 may be communicatively coupled with more than one port 120 of the multi-port memory storage 210.

The communication infrastructure 230 may comprise a printed circuit board on which various elements of the data processing system 201 (e.g., multi-port memory storage 210, client subsystems 140) are attached. For example, the communication infrastructure 230 may comprise metal traces that communicatively couple the various elements as described herein. In some aspects, the communication infrastructure 230 may comprise connectors (not shown) compliant with a storage communication protocol (e.g., NVMe, PCI, PCIe) such as SFF-8369 connectors, Ethernet connectors (e.g., RJ45), hard disk drive connectors, and/or any suitable kind of connectors. For example, the communication infrastructure 230 may comprise a PCIe switch configured to connect a client subsystem 140 with a corresponding port 120. Alternatively or additionally, the communication infrastructure 230 may comprise twisted pair wires, coaxial cable, optical fiber, radio waves or other communication media for connecting the various elements of the data processing system 201. The client subsystems 140 and other elements (not shown) may be communicatively coupled with the network 150 via the communication infrastructure 230 using twisted pair wires, coaxial cable, optical fiber, radio waves or other communication media. Alternatively or additionally, the client subsystems 140 and other elements may be directly connected to the network 150.

Continuing to refer to FIG. 2, the multi-port memory storage 210 may implement, incorporate, and/or otherwise include one or more aspects of dual-port memory storage 110. Alternatively or additionally, the multi-port memory storage 210 may include additional features not mentioned above in reference to dual-port memory storage 110. For example, the multi-port memory storage 210 may be configured to provide one read-only port 120 (e.g., 120A) and the remaining ports 120 (e.g., 120B-N) may be configured as read-write ports. In some aspects, the multi-port memory storage 210 may be configured to provide one read-write port 120 (e.g., 120A) and the remaining ports 120 (e.g., 120B-N) may be configured as read-only ports. In other aspects, the multi-port memory storage 210 may be configured to provide P read-only controllers and R read-write controllers, where P and R are integers greater than 1.

The multi-port memory storage 210 may comprise the command filter component 112 configured to provide read-only access to a shared portion of the multi-port memory storage 210 to a client subsystem 140 communicatively coupled with the multi-port memory storage 210 via a read-only port 120 while providing read-write access to the shared portion of the dual-port memory storage 110 to a client subsystem 140 communicatively coupled with the multi-port memory storage 210 via a read-write port 120. In some aspects, the command filter component 112 may be configured to filter memory access commands according to the read-only access configuration and the read-write access configuration. That is, the command filter component 112 may cause memory access commands to be processed, rejected, or ignored based at least on the read-only access configuration or the read-write access configuration. Alternatively or additionally, the command filter component 112 may be configured to resist tampering or modification of the read-only access configuration and the read-write access configuration of the multi-port memory storage 210.

The multi-port memory storage 210 may comprise a non-volatile memory 115 that may be accessed by the client subsystems 140 via the ports 120. As described in further detail above in reference to FIG. 1, a configuration of the corresponding port 120 with which the client subsystem 140 communicates with the multi-port memory storage 210 may determine the type of access permitted to a shared namespace of the multi-port memory storage 210. For example, a client subsystem 140 communicatively coupled with multi-port memory storage 210 via a read-only port 120 may be provided read-only access to the shared namespace of the multi-port memory storage 210. In another example, another client subsystem 140 communicatively coupled with multi-port memory storage 210 via a read-write port 120 may be provided read-write access to the shared namespace of the multi-port memory storage 210.

In some aspects, the multi-port memory storage 210 may further comprise other namespaces that may be accessed by only one port 120 of the multi-port memory storage 210. For example, the multi-port memory storage 210 may comprise a first namespace that may only be accessed by port 120A. That is, the first namespace may not be accessed via another port 120 (e.g., 120B-N) of the multi-port memory storage 210. Alternatively or additionally, the multi-port memory storage 210 may comprise a second namespace that may only be accessed by port 120B. That is, the second namespace may not be accessed via another port 120 (e.g., 120A, 120N) of the multi-port memory storage 210.

In other aspects, the multi-port memory storage 210 may further comprise other shared namespaces that may be shared amongst other combinations of client subsystems 140. For example, the multi-port memory storage 210 may comprise a first shared namespace and a second namespace. In such a scenario, the multi-port memory storage 210 may be configured to provide read-only access to the first shared namespace via a first port 120 (e.g., 120A), read-write access to the first shared namespace via a second port 120 (e.g., 120B), read-only access to the second shared namespace via a third port 120 (e.g., 120C), and read-write access to the second shared namespace via a fourth port 120 (e.g., 120D). Alternatively or additionally, the first port 120 and the second port 120 may not access the second shared namespace and/or the third port 120 and the fourth port 120 may not access the first shared namespace.

The multi-port memory storage 210 may receive memory access commands that act on a particular namespace or a range of namespaces. As described in further detail above in reference to FIG. 1, the memory access commands may comprise read commands for retrieving data stored in a namespace of the non-volatile memory 115, write commands for modifying data in a namespace of the non-volatile memory 115, and commands for administration, configuration, and/or management of the multi-port memory storage 210 and/or of the data contained by the non-volatile memory 115. The memory access commands may be received from the client subsystems 140 via the ports 120 of the multi-port memory storage 210. The memory access commands may comply with one or more NVMe standards, and/or with one or more other memory storage standards.

The multi-port memory storage 210 may be further configured to prevent tampering with the configuration of the multi-port memory storage 210. For example, the multi-port memory storage 210 may deny or prevent additions, deletions, or modifications to the configuration and/or instructions implementing the configuration and functionality of the ports 120. That is, the command filter component 112 may filter out or reject commands for administration, configuration, and/or management of the multi-port memory storage 210 and/or of the data contained by the non-volatile memory 115 (e.g., “firmware commit” command, “firmware image download” command, “format” command). In other aspects, the multi-port memory storage 210 may continuously monitor the configuration and/or instructions of the ports 120 to detect changes. Thus, the multi-port memory storage 210, as described herein, may allow clients to securely share data comprised by the multi-port memory storage 210 without a need to copy or transfer data from one namespace to another namespace of the multi-port memory storage 210 or from the multi-port memory storage 210 to another memory storage device.

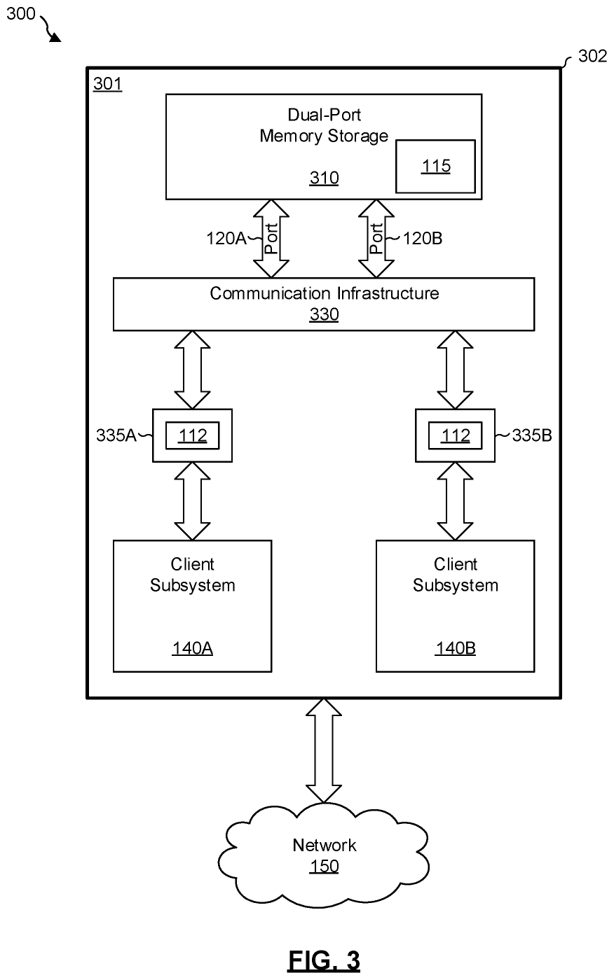

FIG. 3 illustrates another example of a system architecture and a data processing system that may be used to implement one or more illustrative aspects described herein in a standalone and/or networked environment. The architecture of the data processing system depicted in FIG. 3 is similar in many respects to the architecture of the data processing systems 101 and 201 described above with reference to FIGS. 1 and 2 and may include additional features not mentioned above. In the illustrated embodiment, the data processing system 301 may include a chassis 302 that houses the components of the data processing system 301, only some of which are illustrated below.

The data processing device system 301 may comprise two client subsystems 140A-140B (generally referred to herein as “client subsystem(s) 140”), a dual-port memory storage 310, a communication infrastructure 330, and two command filtering devices 335A-335B (generally referred to herein as “command filtering device(s) 335”). The data processing device system 301 may be configured to provide to one client subsystem 140 read-write access to a shared portion of the dual-port memory storage 310 and to provide to the other client subsystem 140 read-only access to the shared portion of the dual-port memory storage 310.

The chassis 302 may house the components comprised by the data processing device system 301 (i.e., the client subsystems 140, the dual-port memory storage 310, the communication infrastructure 330, and the command filtering devices 335). Alternatively or additionally, the chassis 302 may comprise multiple enclosures that separately house the components of the data processing device system 301. In some aspects, the chassis 302 may house additional components such as power supplies, fans, and the like, which have been omitted for the sake of simplicity.

The client subsystem 140A may be communicatively coupled with a port 120A of the dual-port memory storage 310 via the communication infrastructure 330 and a command filtering device 335A. The client subsystem 140B may be communicatively coupled with a port 120B of the dual-port memory storage 310 via the communication infrastructure 330 and a command filtering device 335B. In some aspects, the client subsystem 140A may be communicatively coupled with the port 120B of the dual-port memory storage 310 via the command filtering device 335A and the client subsystem 140B may be communicatively coupled with the port 120A of the dual-port memory storage 310 via the command filtering device 335B. That is, each client subsystem 140 may be communicatively coupled with the dual-port memory storage 310 via a corresponding command filtering device 335 (e.g., 335A, 335B) and a corresponding port 120 (e.g., 120A, 120B) of the dual-port memory storage 310. However, in other aspects, only one client subsystem 140 may be communicatively coupled with the corresponding port 120 of the dual-port memory storage 310 via a corresponding command filtering device 335 that is configured for read-only access to the shared namespace of the dual-port memory storage 310. That is, the other client subsystem 140 may be communicatively coupled with the corresponding port 120 of the dual-port memory storage 310 without a command filtering device 335, and as such, be provided with read-write access to the shared namespace of the dual-port memory storage 310.

Continuing to refer to FIG. 3, the dual-port memory storage 310 may implement, incorporate, and/or otherwise include one or more aspects of the dual-port memory storage 110 and the multi-port memory storage 210. Alternatively or additionally, the dual-port memory storage 310 may include additional features not mentioned above in reference to the dual-port memory storage 110 and the multi-port memory storage 210. For example, in some aspects, the dual-port memory storage 310 may comprise a conventional dual-port memory storage device (e.g., a dual port SSD). Conventional dual-port memory storage devices are well known in the art, and therefore may not be described at a sufficient level of detail herein for understanding of the claimed invention. However, it should be understood that the conventional dual-port memory storage device may be configured to comprise a plurality of namespaces, wherein at least one namespace is shared amongst the ports of the dual-port memory storage 310.

Each command filtering device 335 may be communicatively coupled with a corresponding client subsystem 140 and a corresponding port 120 via the communication infrastructure 330. In some aspects, as shown in FIG. 3, the command filtering devices 335 may be disposed between the client subsystems 140 and the communication infrastructure 330. In other aspects (not shown), the command filtering devices 335 may be disposed between the communication infrastructure 330 and the ports 120. In yet other aspects (not shown), the communication infrastructure 330 may comprise the command filtering devices 335. Alternatively or additionally, the command filtering devices 335 may be housed in a single enclosure or device.

The command filtering device 335 may comprise the command filter component 112, as described above with reference to FIGS. 1 and 2. As such, the discussion of the command filter component 112 of FIGS. 1 and 2 is sufficient for understanding the functionality of the command filtering device 335. However, it should be understood that the command filtering device 335 may be configured to filter memory access commands from the client subsystems 140 prior to being received by the dual-port memory storage 310 via a corresponding port 120. That is, a command filtering device 335 configured for read-only access may filter out (e.g., prevent receipt of) write commands for the shared namespace from the client subsystem 140 with which the particular command filtering device 335 is coupled. Alternatively or additionally, another command filtering device 335 that is configured for read-write access may pass-through read and write commands for the shared namespace from the client subsystem 140 with which the another command filtering device 335 is coupled. In this way, the command filtering devices 335 may facilitate the read-only port configuration and the read-write port configuration of the dual-port memory storage 310. For example, a client subsystem 140 that is communicatively coupled with the dual-port memory storage 310 via the read-only command filtering device 335 may read data stored in the shared namespace, but may be prevented by the read-only command filtering device 335 from writing data to the shared namespace. In another example, another client subsystem 140 that is communicatively coupled with the dual-port memory storage 310 via the read-write command filtering device 335 may read data from the shared namespace and write data to the shared namespace.

The command filtering devices 335 may comply with one or more NVMe standards. For example, the command filtering devices 335 may filter or pass-through memory access commands to the dual-port memory storage 310 that comply with a NVMe standard. Alternatively or additionally, the command filtering devices 335 may comply with one or more other memory storage standards. In some aspects, the command filtering devices 335 may comply with a Peripheral Component Interconnect (PCI) standard, a PCI Express (PCIe) standard, or a NVMe over Fabrics standard. Alternatively or additionally, the command filtering devices 335 may comprise a connector (not shown) compliant with a storage communication protocol (e.g., NVMe, PCI, PCIe) such as an SFF-8369 connector, an Ethernet connector (e.g., RJ45), a hard disk drive connector, a connector type used to connect computer peripherals, a connector used to connect network storage, and/or any suitable kind of connector.

The command filtering devices 335 may implement the command filter component 112 using hardware, software, or a combination thereof. For example, the command filtering devices 335 may comprise one or more FPGAs or ASICs (not shown) configured to implement the command filter component 112. That is, the one or more FPGAs or ASICs may be configured to pass-through read commands for data stored in the namespaces of the dual-port memory storage 310. The one or more FPGAs or ASICs may be further configured to filter out write commands for data stored in the shared namespace if or when configured for read-only access of the dual-port memory storage 310. The one or more FPGAs or ASICs may be further configured to pass-through read and write commands for data stored in the namespaces if or when configured for read-write access of the dual-port memory storage 310. In some aspects, the command filtering devices 335 may be configured as a NVMe bridge that intercepts NVMe protocol commands prior to passing the commands to the dual-port memory storage 310 via the communication infrastructure 330.

The one or more FPGAs or ASICs of the command filtering devices 335 may be further configured to resist tampering with the configuration of the one or more FPGAs or ASICs. That is, the one or more FPGAs or ASICs may deny or prevent additions, deletions, or modifications to the configuration and/or instructions of the one or more FPGAs. For example, the one or more FPGAs or ASICs may filter out commands for administration, configuration, and/or management of the dual-port memory storage 310 and/or of the data contained by the non-volatile memory 115 (e.g., “firmware commit” command, “firmware image download” command, “format” command). In other aspects, the one or more FPGAs or ASICs may continuously monitor the configuration and/or instructions of the one or more FPGAs or ASICs to detect single or multiple-bit changes. Thus, the data processing device system 301, as described herein, may allow clients to securely share data comprised by the dual-port memory storage 310 without a need to copy or transfer data from one namespace to another namespace of the dual-port memory storage 310 or from the dual-port memory storage 310 to another memory storage device.

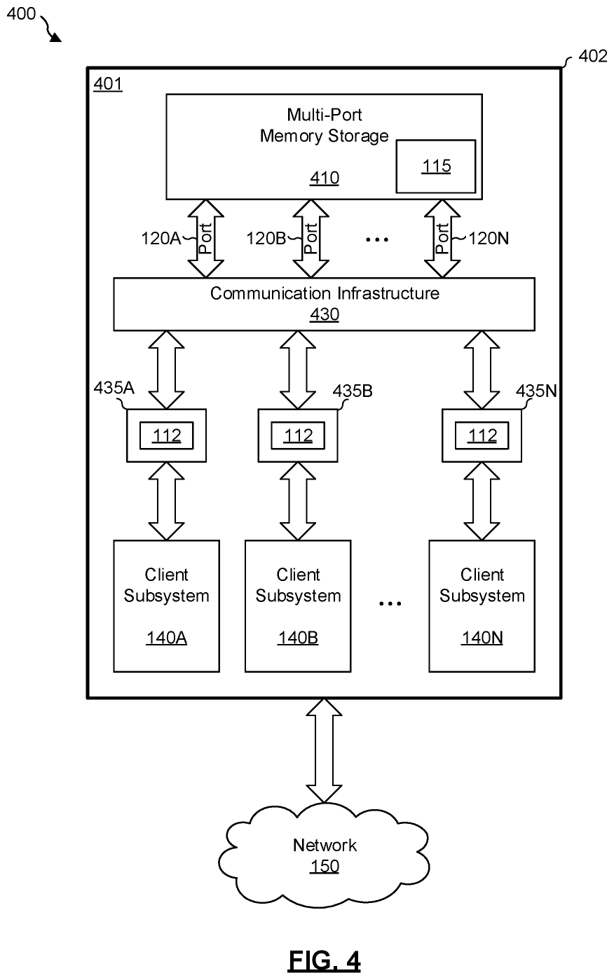

FIG. 4 depicts another illustrative system architecture and data processing system that may be used to implement one or more illustrative aspects described herein in a standalone and/or networked environment. As seen in FIG. 4, data processing system 401 comprises client subsystems 140A-N communicatively coupled with a respective ports 120 (e.g., 120A-N) of a multi-port memory storage 410 via respective command filtering devices 335 (e.g., 335A-N). The architecture of the data processing system 401 depicted in FIG. 4 is similar in many respects to the architecture of the data processing systems 101, 201, and 301 described above with reference to FIGS. 1-3 and may include additional features no mentioned above.

The data processing device system 401 may include a chassis 402 that houses the components of the data processing device system 401, only some of which are illustrated below. The chassis 402 may house N client subsystems 140A-140N (generally referred to herein as “client subsystem(s) 140”), a multi-port memory storage 410, a communication infrastructure 430, and N command filtering devices 335A-N (generally referred to herein as “command filtering device(s) 335”), where N is an integer greater than 2 (i.e., 3, 4, 5, . . . ). Each client subsystem of the N client subsystems 140 may be communicatively coupled with a corresponding port 120A-120N (generally referred to herein as “port(s) 120”) of the multi-port memory storage 410 via the communication infrastructure 430 and a corresponding command filtering device 335. For example, the client subsystem 140A may be communicatively coupled with a port 120A of the multi-port memory storage 410 via the communication infrastructure 430 and a command filtering device 335A, the client subsystem 140B may be communicatively coupled with a port 120B of the multi-port memory storage 410 via the communication infrastructure 430 and a command filtering device 335B, and the client subsystem 140N may be communicatively coupled with a port 120N of the multi-port memory storage 410 via the communication infrastructure 430 and a command filtering device 335N. That is, each client subsystem 140 may be communicatively coupled with via a corresponding port 120 of the multi-port memory storage 410 via the communication infrastructure 430 and a corresponding command filtering device 335. Alternatively or additionally, a client subsystem 140 may be communicatively coupled with more than one port 120 of the multi-port memory storage 410. In other aspects, a client subsystem 140 may be communicatively coupled with a port 120 of the multi-port memory storage 410 only via the communication infrastructure 430. That is, the particular client subsystem 140 may not be communicatively coupled with the particular port 120 of the multi-port memory storage 410 via a command filtering device 335.

The communication infrastructure 430 may comprise a printed circuit board on which various elements of the data processing device system 401 (e.g., multi-port memory storage 410, command filtering devices 335) are attached. For example, the communication infrastructure 430 may comprise metal traces that communicatively couple the various elements as described herein. In some aspects, the communication infrastructure 430 may comprise connectors (not shown) compliant with a storage communication protocol (e.g., NVMe, PCI, PCIe) such as SFF-8369 connectors, Ethernet connectors (e.g., RJ45), hard disk drive connectors, and/or any suitable kind of connectors. For example, the communication infrastructure 430 may comprise a PCIe switch configured to connect a command filtering device 335 with a corresponding port 120. Alternatively or additionally, the communication infrastructure 430 may comprise twisted pair wires, coaxial cable, optical fiber, radio waves or other communication media for connecting the various elements of the data processing device system 401. The client subsystems 140 and other elements (not shown) may be communicatively coupled with the network 150 via the communication infrastructure 430 using twisted pair wires, coaxial cable, optical fiber, radio waves or other communication media. Alternatively or additionally, the client subsystems 140 and other elements may be directly connected to the network 150.

Continuing to refer to FIG. 4, the multi-port memory storage 410 may implement, incorporate, and/or otherwise include one or more aspects of the dual-port memory storage 110 and 310 and the multi-port memory storage 210. Alternatively or additionally, the multi-port memory storage 410 may include additional features not mentioned above in reference to the dual-port memory storage 110 and 310 and the multi-port memory storage 210.

The multi-port memory storage 410 may comprise a non-volatile memory 115 that may be accessed by the client subsystems 140 via a corresponding port 120 and a corresponding command filtering device 335. As described in further detail above in reference to FIG. 3, a configuration of the corresponding command filtering device 335 with which the client subsystem 140 communicates with the multi-port memory storage 410 may determine the type of access permitted to a shared namespace of the multi-port memory storage 410. For example, a client subsystem 140 communicatively coupled with the multi-port memory storage 410 via a command filtering device 335 configured for read-only access may be provided read-only access to the shared namespace of the multi-port memory storage 410. In another example, another client subsystem 140 communicatively coupled with multi-port memory storage 410 via a command filtering device 335 configured for read-write access may be provided read-write access to the shared namespace of the multi-port memory storage 410.

The command filtering devices 335 depicted in FIG. 4 are similar in many respects to the command filter component 112, as described above with reference to FIGS. 1 and 2, and to the command filtering devices 335 described above with reference to FIG. 3, and may include additional features no mentioned above. As such, the discussions of the command filter component 112 of FIGS. 1 and 2, and the command filtering devices 335 of FIG. 3 are sufficient for understanding the functionality of the command filtering device 335 of FIG. 4.

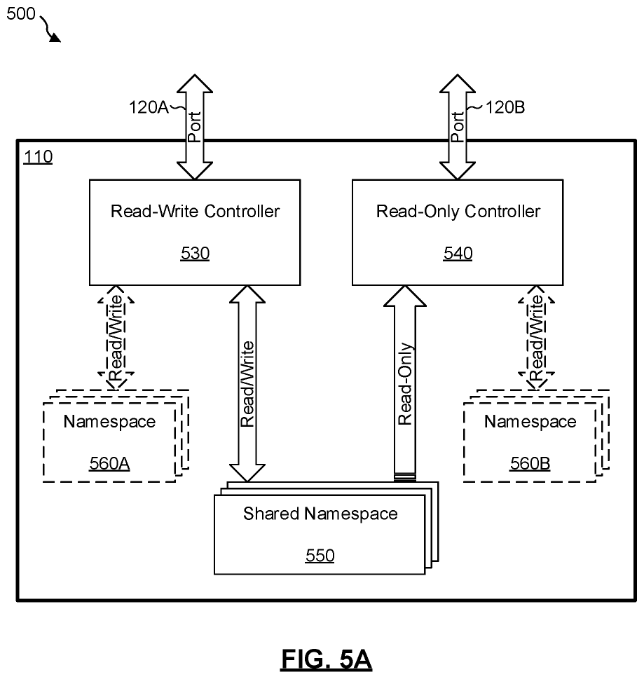

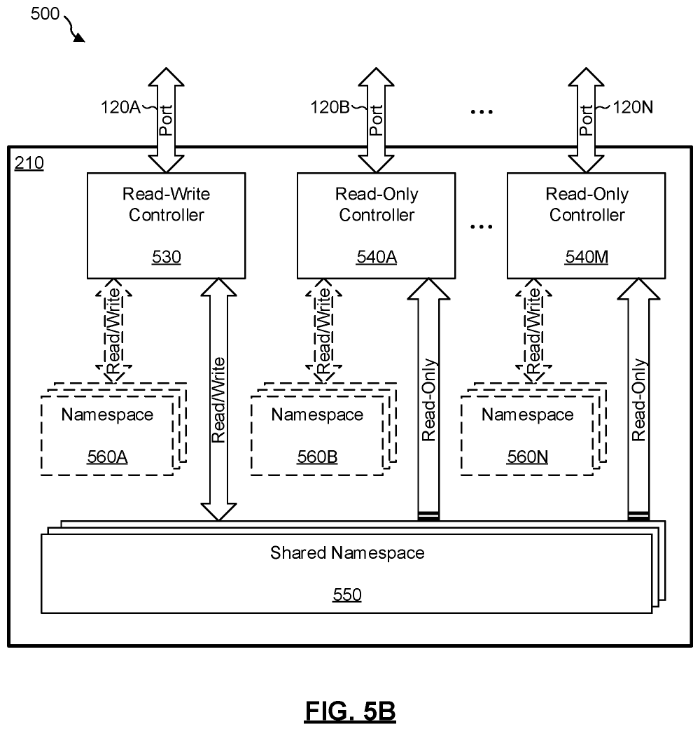

Referring to FIGS. 5A-5C, the diagrams illustrate examples of memory storage devices that may be used for secure data sharing between client subsystems of the data processing systems described above in FIGS. 1-2. The memory storage devices depicted in FIGS. 5A-5C are similar in many respects to the memory storage devices described above with reference to FIGS. 1-2 and may include additional features not mentioned above.

FIG. 5A is a diagram illustrating an exemplary dual-port memory storage device 110 that may be used by data processing system 101 described above in reference to FIG. 1. The dual-port memory storage device 110 may comprise ports 120A-B. Each port 120 of the dual-port memory storage device 110 may be controlled by a corresponding controller. For example, port 120A may be controlled by read-write controller 530 and port 120B may be controlled by read-only controller 540. In other aspects, port 120A may be controlled by read-only controller 540 and port 120 may be controlled by read-write controller 530.

A client subsystem 140, which is communicatively coupled with a corresponding port 120 of the dual-port memory storage device 110, may send memory access commands to the dual-port memory storage device 110 via the corresponding port 120. The memory access commands may comprise commands for reading data stored in the dual-port memory storage device 110 (e.g., “read,” “compare,” “verify”). The memory access commands may further comprise commands for storing data in the dual-port memory storage device 110 (e.g., “write,” “flush,” “write zeroes”). In some aspects, the memory access commands may comprise commands for administration, configuration, and/or management of the dual-port memory storage 110 and/or of the data contained by the dual-port memory storage 110 (e.g., “firmware commit,” “firmware image download,” “format”). The controller (e.g., 530, 540) corresponding to the port 120 may receive the memory access commands sent by the client subsystem 140. The controllers (e.g., 530 and 540) may comply with one or more NVMe standards. For example, the memory access commands sent by the client subsystem 140 comply with a NVMe standard. Alternatively or additionally, the controllers (e.g., 530 and 540) may comply with one or more other memory storage standards. In some aspects, the controllers (e.g., 530 and 540) may comply with a PCI standard, a PCIe standard, or a NVMe over Fabrics standard.

The read-write controller 530 and the read-only controller 540 may be configured to process the memory access commands received via the port 120 corresponding to the controller. In some aspects, the read-write controller 530 may comprise a command filter component 112 (not shown) configured to provide read-write access to a shared namespace 550 of the dual-port memory storage 110. Alternatively or additionally, the read-only controller 540 may comprise a command filter component 112 (not shown) configured to provide read-only access to the shared namespace 550 of the dual-port memory storage 110. In other aspects, the read-write controller 530 and the read-only controller 540 may each comprise a submission queue in which the received memory access commands are placed for processing. Alternatively or additionally, the read-write controller 530 and the read-only controller 540 may each comprise a completion queue in which memory access commands are placed after completion of processing the memory access commands. In some aspects, each completion queue may comprise results and/or status codes associated with the processed memory access commands. The read-write controller 530 and the read-only controller 540 may be configured to provide the results and/or status codes of the process memory access commands to the client subsystem 140 communicatively coupled with the port 120 corresponding to the controller (e.g., 530 or 540).

The read-write controller 530 and the read-only controller 540 may each support one or more namespaces. Each namespace may refer to a distinct portion of the non-volatile memory 115 of the dual-port memory storage 110. For example, a namespace may indicate a collection of logical blocks in the non-volatile memory 115 and whose logical block addresses may range from zero to the size of the namespace minus one (1). Each namespace may be identified via a namespace ID that may be used by the controllers (e.g., 530, 540) to provide access to the namespace.

The read-write controller 530 may be configured to provide read-write access to the shared namespace 550. That is, the read-write controller 530 may accept and/or process read and write memory access commands for the shared namespace 550 received via the port 120 corresponding to the read-write controller 530 (e.g., port 120A). For example, a client subsystem 140 communicatively coupled with the port 120 corresponding to the read-write controller 530 may perform read and write operations on data stored by memory locations comprised by the shared namespace 550. Alternatively or additionally, the read-write controller 530 may be configured to provide read-write access to at least one private namespace 560A. That is, the read-write controller 530 may accept and/or process read and write memory access commands for the at least one private namespace 560A received via the port 120 corresponding to the read-write controller 530 (e.g., port 120A). For example, a client subsystem 140 communicatively coupled with the port 120 corresponding to the read-write controller 530 may perform read and write operations on data stored by memory locations comprised by the at least one private namespace 560A.

The read-only controller 540 may be configured to provide read-only access to the shared namespace 550. That is, the read-only controller 540 may accept and/or process read memory access commands for the shared namespace 550 received via the port 120 corresponding to the read-only controller 540 (e.g., port 120B), while rejecting write memory access commands for the shared namespace 550. For example, a client subsystem 140 communicatively coupled with the port 120 corresponding to the read-only controller 540 may only perform read operations on data stored by memory locations comprised by the shared namespace 550. Alternatively or additionally, the read-only controller 540 may be configured to provide read-write access to at least one private namespace 560B. That is, the read-only controller 540 may accept and/or process read and write memory access commands for the at least one private namespace 560B received via the port 120 corresponding to the read-only controller 540 (e.g., port 120B). For example, a client subsystem 140 communicatively coupled with the port 120 corresponding to the read-only controller 540 may perform read and write operations on data stored by memory locations comprised by the at least one private namespace 560B.

In some aspects, the configuration of the read-write controller 530 of the dual-port memory storage 110 may be implemented using hardware, software, or a combination thereof. Alternatively or additionally, the configuration of the read-only controller 540 of the dual-port memory storage 110 may be implemented using hardware, software, or a combination thereof. For example, the dual-port memory storage 110 may comprise one or more FPGAs or ASICs (not shown) configured to implement the read-write controller 530 and/or the read-only controller 540. The one or more FPGAs or ASICs may be further configured to implement the command filter component 112. That is, the one or more FPGAs or ASICs may be configured to process memory access commands for the shared namespace 550 received via the port 120A. The one or more FPGAs or ASICs may be further configured to process only read commands for the shared namespace 550 received via the port 120B.

The one or more FPGAs or ASICs may be further configured to prevent tampering with the configuration of the one or more FPGAs or ASICs. For example, the one or more FPGAs or ASICs may deny or prevent additions, deletions, or modifications to the configuration and/or instructions of the one or more FPGAs or ASICs. For example, the one or more FPGAs or ASICs may filter out or reject commands for administration, configuration, and/or management of the dual-port memory storage 110 and/or of the data contained by the non-volatile memory 115 (e.g., “firmware commit” command, “firmware image download” command, “format” command). In other aspects, the one or more FPGAs or ASICs may continuously monitor the configuration and/or instructions of the one or more FPGAs or ASICs to detect single or multiple-bit changes. Thus, the dual-port memory storage 110, as described herein, may allow clients to securely share data comprised by the dual-port memory storage 110 without a need to copy or transfer data from one namespace to another namespace of the dual-port memory storage 110 or from the dual-port memory storage 110 to another memory storage device.

FIG. 5B is a diagram illustrating an exemplary multi-port memory storage device 210 that may be used by data processing system 201 described above in reference to FIG. 2. The multi-port memory storage device 210 may comprise ports 120A-N. Each port 120 of the multi-port memory storage device 210 may be controlled by a corresponding controller. For example, port 120A may be controlled by read-write controller 530, port 120B may be controlled by a read-only controller 540A, and port 120N may be controlled by a read-only controller 540M.

A client subsystem 140, which is communicatively coupled with a corresponding port 120 of the multi-port memory storage device 210, may send memory access commands to the multi-port memory storage device 210 via the corresponding port 120. The memory access commands may comprise commands for reading data stored in the namespaces of the multi-port memory storage device 210 (e.g., “read,” “compare,” “verify”). The memory access commands may further comprise commands for storing data in the namespaces of the multi-port memory storage device 210 (e.g., “write,” “flush,” “write zeroes”). In some aspects, the memory access commands may comprise commands for administration, configuration, and/or management of the multi-port memory storage device 210 and/or of the data contained by the multi-port memory storage device 210 (e.g., “firmware commit,” “firmware image download,” “format”). The controller (e.g., 530, 540A-M) corresponding to the port 120 may receive the memory access commands sent by the client subsystem 140. The controllers (e.g., 530 and 540A-M) may comply with one or more NVMe standards. For example, the memory access commands sent by the client subsystem 140 may comply with a NVMe standard. Alternatively or additionally, the controllers (e.g., 530 and 540A-M) may comply with one or more other memory storage standards. In some aspects, the controllers (e.g., 530 and 540A-M) may comply with a PCI standard, a PCIe standard, or a NVMe over Fabrics standard.

The read-write controller 530 and the read-only controllers 540A-M may be configured to process the memory access commands received via the port 120 corresponding to the controller. In some aspects, the read-write controller 530 may comprise a command filter component 112 (not shown) configured to provide read-write access to a shared namespace 550 of the multi-port memory storage 210. Alternatively or additionally, the read-only controllers 540A-M may comprise a command filter component 112 (not shown) configured to provide read-only access to the shared namespace 550 of the multi-port memory storage 210. In other aspects, the read-write controller 530 and the read-only controllers 540A-M may each comprise a submission queue in which the received memory access commands are placed for processing. Alternatively or additionally, the read-write controller 530 and the read-only controllers 540A-M may each comprise a completion queue in which memory access commands are placed after completion of processing the memory access commands. In some aspects, each completion queue may comprise results and/or status codes associated with the processed memory access commands. In other aspects, each completion queue may further comprise an indication that the memory access command has been rejected. The read-write controller 530 and the read-only controllers 540A-M may be configured to provide the results and/or status codes of the process memory access commands to the client subsystem 140 communicatively coupled with the port 120 corresponding to the controller (e.g., 530 or 540A-M).

The read-write controller 530 and the read-only controllers 540A-M may each support one or more namespaces. Each namespace may refer to a distinct portion of the non-volatile memory 115 of the multi-port memory storage 210. For example, a namespace may indicate a collection of logical blocks in the non-volatile memory 115 and whose logical block addresses may range from zero to the size of the namespace minus one (1). Each namespace may be identified via a namespace ID that may be used by the controllers (e.g., 530, 540A-M) to provide access to the namespace.

The read-write controller 530 may be configured to provide read-write access to the shared namespace 550. That is, the read-write controller 530 may accept and/or process read and write memory access commands for the shared namespace 550 received via the port 120 corresponding to the read-write controller 530 (e.g., port 120A). For example, a client subsystem 140 communicatively coupled with the port 120 corresponding to the read-write controller 530 may perform read and write operations on data stored by memory locations comprised by the shared namespace 550. Alternatively or additionally, the read-write controller 530 may be configured to provide read-write access to at least one private namespace 560A. That is, the read-write controller 530 may accept and/or process read and write memory access commands for the at least one private namespace 560A received via the port 120 corresponding to the read-write controller 530 (e.g., port 120A). For example, a client subsystem 140 communicatively coupled with the port 120 corresponding to the read-write controller 530 may perform read and write operations on data stored by memory locations comprised by the at least one private namespace 560A.

The read-only controllers 540A-M may be configured to provide read-only access to the shared namespace 550. That is, the read-only controllers 540A-M may accept and/or process read memory access commands for the shared namespace 550 received via the port 120 corresponding to the read-only controllers 540A-N (e.g., port 120B-N), while rejecting write memory access commands for the shared namespace 550. For example, a client subsystem 140 communicatively coupled with the port 120 corresponding to the read-only controller 540 may only perform read operations on data stored by memory locations comprised by the shared namespace 550. Alternatively or additionally, the read-only controllers 540A-M may be configured to provide read-write access to at least one private namespace 560 (e.g., 560B). That is, the read-only controllers 540A-M may accept and/or process read and write memory access commands for the at least one private namespace 560 received via the port 120 corresponding to the read-only controller 540 (e.g., port 120B). For example, a client subsystem 140 communicatively coupled with the port 120 corresponding to the read-only controller 540 may perform read and write operations on data stored by memory locations comprised by the at least one private namespace 560.

In some aspects, the configuration of the read-write controller 530 of the multi-port memory storage 210 may be implemented using hardware, software, or a combination thereof. Alternatively or additionally, the configuration of the read-only controllers 540A-M of the multi-port memory storage 210 may be implemented using hardware, software, or a combination thereof. For example, the multi-port memory storage 210 may comprise one or more FPGAs or ASICs (not shown) configured to implement the read-write controller 530 and/or the read-only controllers 540A-M. The one or more FPGAs or ASICs may be further configured to implement the command filter component 112. That is, the one or more FPGAs or ASICs may be configured to process memory access commands for the shared namespace 550 received via the port 120A. The one or more FPGAs or ASICs may be further configured to process only read commands for the shared namespace 550 received via the port 120B.

The one or more FPGAs or ASICs may be further configured to prevent tampering with the configuration of the one or more FPGAs or ASICs. For example, the one or more FPGAs or ASICs may deny or prevent additions, deletions, or modifications to the configuration and/or instructions of the one or more FPGAs or ASICs. For example, the one or more FPGAs or ASICs may filter out or reject commands for administration, configuration, and/or management of the multi-port memory storage 210 and/or of the data contained by the non-volatile memory 115 (e.g., “firmware commit” command, “firmware image download” command, “format” command). In other aspects, the one or more FPGAs or ASICs may continuously monitor the configuration and/or instructions of the one or more FPGAs or ASICs to detect single or multiple-bit changes. Thus, the multi-port memory storage 210, as described herein, may allow clients to securely share data comprised by the multi-port memory storage 210 without a need to copy or transfer data from one namespace to another namespace of the multi-port memory storage 210 or from the multi-port memory storage 210 to another memory storage device.

FIG. 5C is a diagram illustrating another exemplary multi-port memory storage device 210 that may be used by data processing system 201 described above in reference to FIG. 2. The multi-port memory storage device 210 may comprise ports 120A-N. Each port 120 of the multi-port memory storage device 210 may be controlled by a corresponding controller. The multi-port memory storage device 210 depicted in FIG. 5C is similar in many respects to the memory storage device 210 described above with reference to FIG. 5B and may include additional features not mentioned above. For example, the multi-port memory storage device 210 depicted in FIG. 5C may be configured with a different combination of read-write controllers 530 and read-only controllers 540. As illustrated in FIG. 5C, port 120A may be controlled by read-only controller 540, port 120B may be controlled by a read-write controller 530A, and port 120N may be controlled by a read-write controller 530N.

A client subsystem 140, which is communicatively coupled with a corresponding port 120 of the multi-port memory storage device 210, may send memory access commands to the multi-port memory storage device 210 via the corresponding port 120. The memory access commands may comprise commands for reading data stored in the multi-port memory storage device 210 (e.g., “read,” “compare,” “verify”). The memory access commands may further comprise commands for storing data in the multi-port memory storage device 210 (e.g., “write,” “flush,” “write zeroes”). In some aspects, the memory access commands may comprise commands for administration, configuration, and/or management of the multi-port memory storage device 210 and/or of the data contained by the multi-port memory storage device 210 (e.g., “firmware commit,” “firmware image download,” “format”). The controller (e.g., 530A-M, 540) corresponding to the port 120 may receive the memory access commands sent by the client subsystem 140. The controllers (e.g., 530A-M, 540) may comply with one or more NVMe standards. For example, the memory access commands sent by the client subsystem 140 comply with a NVMe standard. Alternatively or additionally, the controllers (e.g., 530A-M and 540) may comply with one or more other memory storage standards. In some aspects, the controllers (e.g., 530A-M and 540) may comply with a PCI standard, a PCIe standard, or a NVMe over Fabrics standard.

The read-write controllers 530A-M and the read-only controller 540 may be configured to process the memory access commands received via the port 120 corresponding to the controller. In some aspects, the read-write controllers 530A-M may comprise a command filter component 112 (not shown) configured to provide read-write access to a shared namespace 550 of the multi-port memory storage 210. Alternatively or additionally, the read-only controller 540 may comprise a command filter component 112 (not shown) configured to provide read-only access to the shared namespace 550 of the multi-port memory storage 210. In other aspects, the read-write controllers 530A-M and the read-only controller 540 may each comprise a submission queue in which the received memory access commands are placed for processing. Alternatively or additionally, the read-write controllers 530A-M and the read-only controller 540 may each comprise a completion queue in which memory access commands are placed after completion of processing the memory access commands. In some aspects, each completion queue may comprise results and/or status codes associated with the processed memory access commands. The read-write controllers 530A-M and the read-only controller 540 may be configured to provide the results and/or status codes of the process memory access commands to the client subsystem 140 communicatively coupled with the port 120 corresponding to the controller (e.g., 530A-M or 540).

The read-write controllers 530A-M and the read-only controller may each support one or more namespaces. Each namespace may refer to a distinct portion of the non-volatile memory 115 of the multi-port memory storage 210. For example, a namespace may indicate a collection of logical blocks in the non-volatile memory 115 and whose logical block addresses may range from zero to the size of the namespace minus one (1). Each namespace may be identified via a namespace ID that may be used by the controllers (e.g., 530A-M, 540) to provide access to the namespace.

The read-write controllers 530A-M may be configured to provide read-write access to a shared namespace 550. That is, each of the read-write controllers 530A-M may accept and/or process read and write memory access commands for the shared namespace 550 received via the port 120 corresponding to the read-write controllers 530A-M (e.g., port 120B). For example, a client subsystem 140 communicatively coupled with the port 120 corresponding to the read-write controllers 530A-M may perform read and write operations on data stored by memory locations comprised by the shared namespace 550. Alternatively or additionally, the read-write controllers 530A-M may be configured to provide read-write access to at least one private namespace 560 (e.g., 560B-M). That is, each of the read-write controllers 530A-M may accept and/or process read and write memory access commands for the at least one private namespace (e.g., 560B-M) received via the port 120 corresponding to the read-write controller 530 (e.g., port 120B). For example, a client subsystem 140 communicatively coupled with the port 120 corresponding to the read-write controller 530A may perform read and write operations on data stored by memory locations comprised by the at least one private namespace 560B.

The read-only controller 540 may be configured to provide read-only access to the shared namespace 550. That is, the read-only controller 540 may accept and/or process read memory access commands for the shared namespace 550 received via the port 120 corresponding to the read-only controller 540 (e.g., port 120A), while rejecting write memory access commands for the shared namespace 550. For example, a client subsystem 140 communicatively coupled with the port 120 corresponding to the read-only controller 540 may only perform read operations on data stored by memory locations comprised by the shared namespace 550. Alternatively or additionally, the read-only controller 540 may be configured to provide read-write access to at least one private namespace 560A. That is, the read-only controller 540 may accept and/or process read and write memory access commands for the at least one private namespace 560A received via the port 120 corresponding to the read-only controller 540 (e.g., port 120A). For example, a client subsystem 140 communicatively coupled with the port 120 corresponding to the read-only controller 540 may perform read and write operations on data stored by memory locations comprised by the at least one private namespace 560A.

In some aspects, the configuration of the read-write controllers 530A-M of the multi-port memory storage 210 may be implemented using hardware, software, or a combination thereof. Alternatively or additionally, the configuration of the read-only controller 530 of the multi-port memory storage 210 may be implemented using hardware, software, or a combination thereof. For example, the multi-port memory storage 210 may comprise one or more FPGAs or ASICs (not shown) configured to implement the read-write controllers 530A-M and/or the read-only controller 540. The one or more FPGAs or ASICs may be further configured to implement the command filter component 112. That is, the one or more FPGAs or ASICs may be configured to process memory access commands for the shared namespace 550 received via the port 120A. The one or more FPGAs or ASICs may be further configured to process only read commands for the shared namespace 550 received via the port 120B.

The one or more FPGAs or ASICs may be further configured to prevent tampering with the configuration of the one or more FPGAs or ASICs. For example, the one or more FPGAs or ASICs may deny or prevent additions, deletions, or modifications to the configuration and/or instructions of the one or more FPGAs or ASICs. For example, the one or more FPGAs or ASICs may filter out or reject commands for administration, configuration, and/or management of the multi-port memory storage 210 and/or of the data contained by the non-volatile memory 115 (e.g., “firmware commit” command, “firmware image download” command, “format” command). In other aspects, the one or more FPGAs or ASICs may continuously monitor the configuration and/or instructions of the one or more FPGAs or ASICs to detect single or multiple-bit changes. Thus, the multi-port memory storage 210, as described herein, may allow clients to securely share data comprised by the multi-port memory storage 210 without a need to copy or transfer data from one namespace to another namespace of the multi-port memory storage 210 or from the multi-port memory storage 210 to another memory storage device.

FIGS. 5A-5C illustrate just some examples of multi-port memory storage devices that may be used, and those of skill in the art will appreciate that the specific device architecture and configuration may vary, and are secondary to the functionality that they provide, as further described herein. In some aspects, the multi-port memory storage 210 may comprise any combination of read-only controllers and read-write controllers. For example, the multi-port memory storage 210 may comprise P read-only controllers and R read-write controllers, where P and R are integers greater than 1.

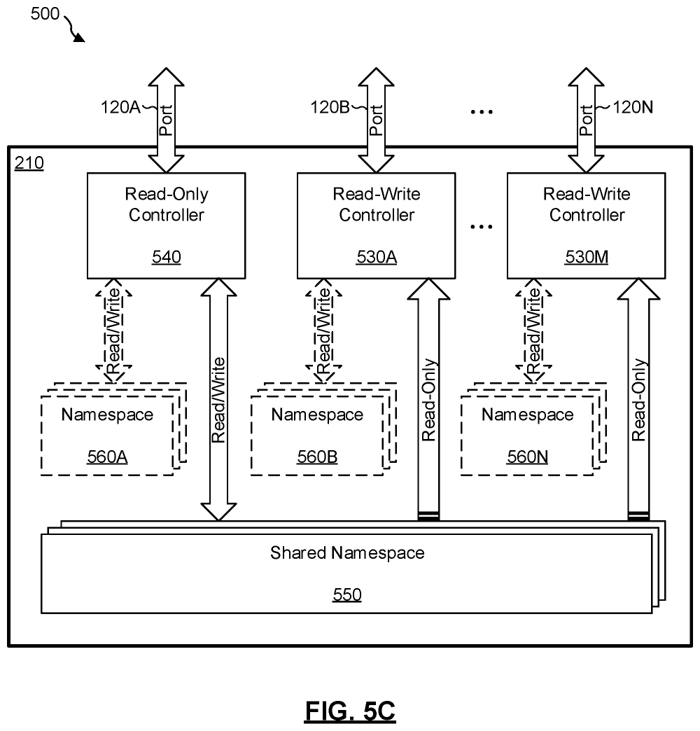

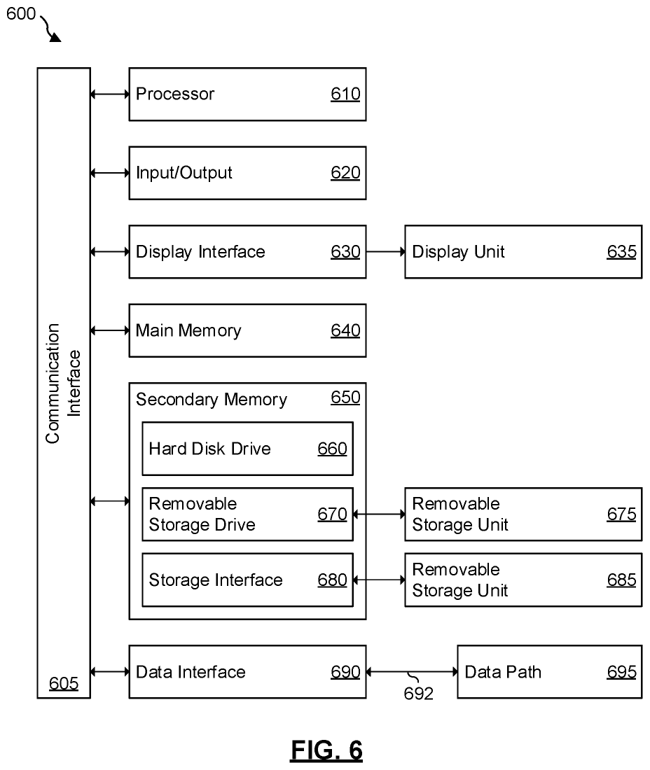

Aspects of the present disclosure may be implemented using hardware, software, or a combination thereof and may be implemented in one or more computer systems or other processing systems. In an aspect of the present disclosure, features are directed toward one or more computer systems capable of carrying out the functionality described herein. An example of such a computer system 600 is shown in FIG. 6.

The computer system 600 may comprise one or more processors, such as processor 610. The processor 610 may be communicatively coupled with a communication interface 605 (e.g., a communications bus, cross-over bar, or network). The processor 610 may control overall operation of the computer system 600 and its associated components, including an input/output module 620, a display interface 630, a main memory 640, a secondary memory 650, and a data interface 690. Various software implementations are described in terms of this example computer system 600. After reading this description, it will become apparent to a person skilled in the relevant art(s) how to implement implementations of the disclosure using other computer systems and/or architectures.

The input/output module 620 may comprise a mouse, a keypad, a touch screen, a scanner, an optical reader, and/or a stylus (or other input device(s)) through which a user of computer system 600 may provide input. Alternatively or additionally, the input/output module 620 may comprise one or more of a speaker (not shown) for providing audio output.

The computer system 600 may comprise a display interface 630 that may forward graphics, text, and other data from the communication interface 605 (or from a frame buffer that is not shown) for display on a display unit 635.

The computer system 600 may further comprise a main memory 640, preferably RAM, and may also comprise a secondary memory 650. The secondary memory 650 may comprise, for example, a hard disk drive 660, and/or a removable storage drive 670, representing a floppy disk drive, a magnetic tape drive, an optical disk drive, a universal serial bus (USB) flash drive, or the like. The removable storage drive 670 may read from and/or write to a removable storage unit 675 in a well-known manner. The removable storage unit 675 may represent a floppy disk, a magnetic tape, an optical disk, a USB flash drive, or the like, which may be read by and written to the removable storage drive 670. As will be appreciated, the removable storage unit 675 may comprise a computer usable storage medium having stored therein computer software and/or data.

Alternative implementations of the present disclosure may comprise other similar devices for loading computer programs or other instructions into the computer system 600. Such devices may include, for example, a removable storage unit 685 and a storage interface 680. Examples of such may include a program cartridge and cartridge interface (such as that found in video game devices), a removable memory chip (such as an EEPROM), or programmable read only memory (PROM)) and associated socket, and other removable storage units 685 and storage interfaces 680, which may provide for software and data to be transferred from the removable storage unit 685 to the computer system 600.

The computer system 600 may also comprise a data interface 690. Data interface 690 may provide for software and data to be transferred between the computer system 600 and external devices. Examples of data interface 690 may comprise a modem, a network interface (such as an Ethernet card), a communications port, a Personal Computer Memory Card International Association (PCMCIA) slot and card, and the like. Software and data transferred via data interface 690 may be in the form of signals 692, which may be electronic, electromagnetic, optical or other signals capable of being received by data interface 690. The signals 692 may be provided to data interface 690 via a data path (e.g., channel) 695. The data path 695 may carry signals 692 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage unit 675, a hard disk installed in hard disk drive 660, and signals 692. These computer program products may provide software to the computer system 600. Implementations of the present disclosure are directed to such computer program products.

Computer programs (also referred to as computer control logic) may be stored in main memory 640 and/or secondary memory 650. The computer programs may also be received via data interface 690. Such computer programs, if or when executed by the computer system 600, may enable the computer system 600 to perform features in accordance with implementations of the present disclosure, as discussed herein. In particular, the computer programs, if or when executed, enable the processor 610 to perform the features in accordance with implementations of the present disclosure. Accordingly, such computer programs represent controllers of the computer system 600.

In an aspect of the present disclosure where the disclosure is implemented using software, the software may be stored in a computer program product and loaded into the computer system 600 using the hard disk drive 660, the removable storage drive 670, or the data interface 690. The control logic (software), if or when executed by the processor 610, may cause the processor 610 to perform the functions described herein. In another aspect, the computer system 600 may be implemented primarily in hardware using, for example, hardware components, such as FPGAs or ASICs. Implementation of the hardware state machine so as to perform the functions described herein will be apparent to persons skilled in the relevant art(s).

FIG. 7 is a block diagram of an example apparatus 700 for controlling access to a memory storage. The apparatus 700 may be a memory storage controller, or a memory storage controller may include the apparatus 700. Alternatively or additionally, the apparatus 700 may be a command filtering device, or a command filtering device may include the apparatus 700. In some aspects, the apparatus 700 may include a client component 710, a memory component 720, and a command filter component 730, which may be in communication with one another (for example, via one or more buses—not shown). As shown, the apparatus 700 may communicate with another apparatus 740 (such as a client subsystem) using the client component 710. The apparatus 700 may also communicate with another apparatus 750 (such as a non-volatile memory or a memory storage) using the memory component 720.

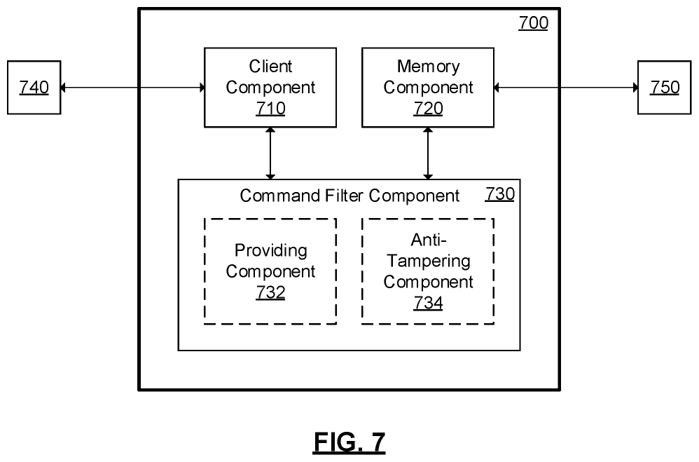

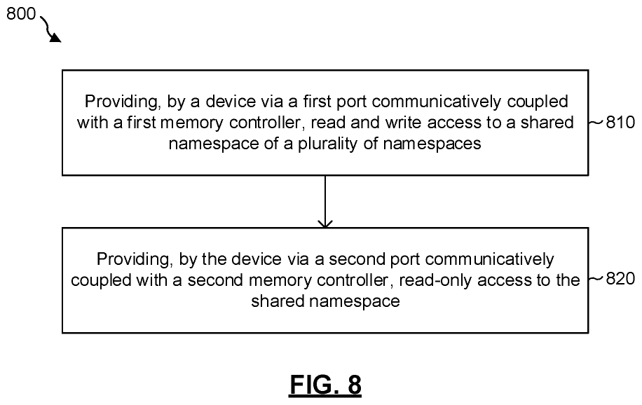

In some aspects, the apparatus 700 may be configured to perform one or more operations described herein in connection with FIGS. 1-5. Additionally or alternatively, the apparatus 700 may be configured to perform one or more processes described herein, such as method 800 of FIGS. 8-14. In some aspects, the apparatus 700 may include one or more components of the command filter component 112 described above in connection with FIGS. 1-2, the command filtering device 335 described above in connection with FIGS. 3-4, and the read-write controller 530 and the read-only controller 540 described above in connection with FIGS. 5A-5C.

The client component 710 may receive and transmit communications, such as memory access commands, control information, data communications, or a combination thereof, with the apparatus 740. The client component 710 may provide received communications to one or more other components of the apparatus 700, such as the command filter component 730. In some aspects, the client component 710 may perform processing on the received communications (such as queuing, prioritization, merging, or fusing, among other examples), and may provide the processed communications to the one or more other components. In some aspects, the client component 710 may receive communications from the one or more other components for transmission to the apparatus 740. The client component 710 may perform processing on the to-be-transmitted communications (such as queuing, prioritization, merging, or fusing, among other examples) prior to transmission to the apparatus 740.

The memory component 720 may retrieve data stored in apparatus 750 and provide the retrieved data to the one or more other components of apparatus 700. Alternatively or additionally, the memory component 720 may store in apparatus 750 data provided by one or more other components of apparatus 700. In some aspects, the memory component 720 may perform non-volatile memory management procedures on apparatus 700 (e.g., wear leveling).

The command filter component 730 may be configured either in a read-only configuration or in a read-write configuration. If or when the command filter component 730 is configured in the read-only configuration, the command filter component 730 may provide read-only access to a shared namespace of a plurality of namespaces in apparatus 750. If or when the command filter component 730 is configured in the read-write configuration, the command filter component 730 may provide read-write access to the shared namespace of the plurality of namespaces in apparatus 750. For example, the command filter component 730 configured in the read-only configuration may receive a write command for the shared namespace from apparatus 740 and the command filter component 730 may filter out the write command and/or prevent the apparatus 740 from writing data to the shared namespace of the apparatus 750. In another example in which the command filter component 730 is configured in the read-write configuration, the command filter component 730 may receive a write command for the shared namespace from the apparatus 740 and the command filter component 730 may pass-through the write command and permit the apparatus 740 to write data to the shared namespace of the apparatus 750. In yet another example, the command filter component 730, configured in either the read-only configuration or the read-write configuration, may receive a read command for the shared namespace from the apparatus 740, and the command filter component 730 may pass-through the read command and permit the apparatus 740 to read data from the shared namespace of the apparatus 750.

In some aspects, the command filter component 730 may comprise a controller/processor, a memory, or a combination thereof, of the controllers described above in connection with FIGS. 5A-5C. In other aspects, the command filter component 730 may comprise a set of components, such as a providing component 732, an anti-tampering component 734, or a combination thereof. Alternatively, the set of components may be separate and distinct from the command filter component 730. In some aspects, one or more components of the set of components may include or may be implemented within a controller/processor, a memory, or a combination thereof, of the controllers described above in connection with FIGS. 5A-5C. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The providing component 732 may provide read and write access to the shared namespace. For example, the providing component 732 may process read and write memory access commands directed to the shared namespace that have been received from a client subsystem based at least on the command filter component 730 being configured in the read-write configuration. For example, the providing component 732 may process read and write memory access commands directed to the shared namespace that have been received from a client subsystem if or when the command filter component 730 is configured in the read-write configuration.

In other aspects, the providing component 732 may provide read-only access to the shared namespace based at least on the command filter component 730 being configured in the read-only configuration. For example, the providing component 732 may process only read memory access commands directed to the shared namespace that have been received from a client subsystem, and may filter out or reject write memory access commands directed to the shared namespace that have been received from the client subsystem.

In optional or additional aspects, the providing component 732 may provide read and write access to another namespace of the plurality of namespaces. For example, the providing component 732 may process read and write memory access commands directed to the another namespace that have been received from a client subsystem. The namespace may only be accessible via the port corresponding to the apparatus 700.

The anti-tampering component 734 may resist attempts to modify executable instructions of the apparatus 700. For example, the anti-tampering component 734 may deny or prevent additions, deletions, or modifications to the configuration and/or instructions of the apparatus 700. That is, the anti-tampering component 734 may filter out or reject commands for administration, configuration, and/or management of the memory storage and/or of the data contained by the memory storage (e.g., “firmware commit” command, “firmware image download” command, “format” command). In some aspects, the anti-tampering component 734 may continuously monitor the configuration and/or instructions of the apparatus 700 to detect changes. Thus, the apparatus 700, as described herein, may allow clients to securely share data comprised by the apparatus 700 without a need to copy or transfer data from one namespace to another namespace of the apparatus 700 or from the apparatus 700 to another memory storage device.

Referring to FIGS. 8-14, in operation, a command filtering device (e.g., 110, 210, 335) may perform a method 800 of controlling access to a memory storage. The method 800 may be performed by the command filtering device (e.g., 110, 210, 335) (which may include the read-write controller 530, the read-only controller 540, and the non-volatile memory 115, and which may be the entire memory storage device or a component of the memory storage device such as the command filter component 112 and the command filter component 730). The method 800 may be performed by the command filter component 730 in communication with a client subsystem 140 and the non-volatile memory 115.

In block 810 of FIG. 8, the method 800 may include providing, by a device via a first port communicatively coupled with a first memory controller, read and write access to a shared namespace of a plurality of namespaces. For example, in an aspect, the command filtering device (e.g., 110, 210, 335), the read-write controller 530, and/or the command filter component 730 may be configured to or may comprise means for providing, by the command filtering device (e.g., 110, 210, 335) via a first read-write port 120 communicatively coupled with a first read-write controller 530, read and write access to a shared namespace 550 of a plurality of namespaces (e.g., 550, 560A-N). Each namespace of the plurality of namespaces (e.g., 550, 560A-N) may refer to a distinct portion of the non-volatile memory 115 of the memory storage device (e.g., 110, 210, 310, 410).

For example, the providing in block 810 may include receiving, by the command filtering device (e.g., 110, 210, 335), a memory access command from a first client subsystem 140 via the read-write port 120. The memory access command may comprise a read command for retrieving data stored in the non-volatile memory 115. Alternatively or additionally, the memory access command may comprise a write command for storing data in the non-volatile memory 115. In some aspects, the memory access command may comprise a command for administration, configuration, and/or management of the memory storage.

The providing in block 810 may further include the command filtering device (e.g., 110, 210, 335) accepting and/or processing read and write memory access commands for the shared namespace 550 received via the read-write port 120 corresponding to the read-write controller 530. For example, the first client subsystem 140, which is communicatively coupled with the read-write port 120 corresponding to the read-write controller 530, may perform read and write operations on data stored by memory locations comprised by the shared namespace 550.

Further, for example, the providing in block 810 may be performed in response to a determination that the memory access command was received via the read-write port 120 of the memory storage device (e.g., 110, 210, 310, 410) and that the memory access command is directed to a shared namespace 550 of the memory storage device (e.g., 110, 210, 310, 410).

In block 820, the method 800 may include providing, by the device via a second port communicatively coupled with a second memory controller, read-only access to the shared namespace. For example, in an aspect, the command filtering device (e.g., 110, 210, 335), the read-only controller 540, and/or the command filter component 730 may be configured to or may comprise means for providing, by the command filtering device (e.g., 110, 210, 335) via a second read-only port 120 communicatively coupled with the second read-only controller 540, read-only access to the shared namespace 550.

For example, the providing in block 820 may include receiving, by the command filtering device (e.g., 110, 210, 335), a memory access command from a second client subsystem 140 via the read-only port 120. The providing in block 820 may further include the command filtering device (e.g., 110, 210, 335) accepting and/or processing a read memory access command for the shared namespace 550 received via the read-only port 120 corresponding to the read-only controller 540, while rejecting write memory access commands for the shared namespace 550. For example, the second client subsystem 140, which is communicatively coupled with the read-only port 120 corresponding to the read-only controller 540, may only perform read operations on data stored by memory locations comprised by the shared namespace 550, and may be prevented from performing write operations on the shared namespace 550.

Further, for example, the providing in block 820 may be performed in response to a determination that the memory access command was received via the read-only port 120 of the memory storage device (e.g., 110, 210, 310, 410) and that the memory access command is directed to the shared namespace 550 of the memory storage device (e.g., 110, 210, 310, 410).

Referring to FIG. 9, in an optional or an additional aspect, in block 910, the providing in block 820 may further include receiving, from a client subsystem via the second port, a first request to read first data from the shared namespace. For example, in an aspect, the command filtering device (e.g., 110, 210, 335), the read-only controller 540, and/or the command filter component 730 may be configured to or may comprise means for receiving, from a client subsystem 140 via the second read-only port 120, a first request to read first data from the shared namespace 550.

For example, the receiving in block 910 may include receiving, by the command filtering device (e.g., 110, 210, 335), a memory access command from a second client subsystem 140 via the read-only port 120. The receiving in block 910 may further include the command filtering device (e.g., 110, 210, 335) accepting and/or processing the read memory access command for the shared namespace 550 received via the read-only port 120 corresponding to the read-only controller 540.

Further, for example, the receiving in block 910 may be performed to initiate a read operation on data stored by memory locations comprised by the shared namespace 550. The receiving in block 910 may be performed in response to a determination that the memory access command was received via the read-only port 120 of the memory storage device (e.g., 110, 210, 310, 410) and that the memory access command is directed to the shared namespace 550 of the memory storage device (e.g., 110, 210, 310, 410).

In block 920 of this optional or additional aspect, the providing in block 820 may further include sending, to the client subsystem via the second port, the first data from the shared namespace, in response to receiving the first request. For example, in an aspect, the command filtering device (e.g., 110, 210, 335), the read-only controller 540, and/or the command filter component 730 may be configured to or may comprise means for sending, to the client subsystem 140 via the second read-only port 120, the first data from the shared namespace 550, in response to receiving the first request.

For example, the sending in block 920 may include sending, by the read-only controller 540 to the second client subsystem 140 via the read-only port 120, results and/or status codes associated with the processed read memory access command.

Further, for example, the sending in block 920 may be performed in response to the second read-only controller 540 receiving the first request to read first data from the shared namespace 550.

In block 930 of this optional or additional aspect, the providing in block 820 may further include receiving, from the client subsystem via the second port, a second request to write second data to the shared namespace. For example, in an aspect, the command filtering device (e.g., 110, 210, 335), the read-only controller 540, and/or the command filter component 730 may be configured to or may comprise means for receiving, from the client subsystem 140 via the second read-only port 120, a second request to write second data to the shared namespace 550.

For example, the receiving in block 930 may include receiving, by the command filtering device (e.g., 110, 210, 335), a write memory access command from the second client subsystem 140 via the read-only port 120. The receiving in block 930 may further include a determination that the write memory access command was received via the read-only port 120 of the memory storage device (e.g., 110, 210, 310, 410) and that the memory access command is directed to the shared namespace 550 of the memory storage device (e.g., 110, 210, 310, 410).

Further, for example, the receiving in block 930 may be performed to attempt to initiate a write operation to store data in memory locations comprised by the shared namespace 550.

In block 940 of this optional or additional aspect, the providing in block 820 may further include rejecting the second request in response to determining that the second request was received by the second controller via the second port. For example, in an aspect, the command filtering device (e.g., 110, 210, 335), the read-only controller 540, and/or the command filter component 730 may be configured to or may comprise means for rejecting the second request in response to determining that the second request was received by the second read-only controller 540 via the second read-only port 120.

For example, the rejecting in block 940 may include sending, by the read-only controller 540 to the second client subsystem 140 via the read-only port 120, results and/or status codes indicating that the write memory access command has been rejected.

Further, for example, the rejecting in block 940 may be performed in response to a determination that the write memory access command was received via the read-only port 120 of the memory storage device (e.g., 110, 210, 310, 410) and that the memory access command is directed to the shared namespace 550 of the memory storage device (e.g., 110, 210, 310, 410).

Referring to FIG. 10, in an optional or an additional aspect, in block 1010, the providing in block 820 may further include receiving, from a client subsystem via the second port, a first request to read first data from the shared namespace. For example, in an aspect, the command filtering device (e.g., 110, 210, 335), the read-only controller 540, and/or the command filter component 730 may be configured to or may comprise means for receiving, from a client subsystem 140 via the second read-only port 120, a first request to read first data from the shared namespace 550.

For example, the receiving in block 1010 may include receiving, by the command filtering device (e.g., 110, 210, 335), a memory access command from a second client subsystem 140 via the read-only port 120. The receiving in block 1010 may further include the command filtering device (e.g., 110, 210, 335) accepting and/or processing the read memory access command for the shared namespace 550 received via the read-only port 120 corresponding to the read-only controller 540.

Further, for example, the receiving in block 1010 may be performed to initiate a read operation on data stored by memory locations comprised by the shared namespace 550. The receiving in block 1010 may be performed in response to a determination that the memory access command was received via the read-only port 120 of the memory storage device (e.g., 110, 210, 310, 410) and that the memory access command is directed to the shared namespace 550 of the memory storage device (e.g., 110, 210, 310, 410).

In block 1020 of this optional or additional aspect, the providing in block 820 may further include sending, to the client subsystem via the second port, the first data from the shared namespace, in response to receiving the first request. For example, in an aspect, the command filtering device (e.g., 110, 210, 335), the read-only controller 540, and/or the command filter component 730 may be configured to or may comprise means for sending, to the client subsystem 140 via the second read-only port 120, the first data from the shared namespace 550, in response to receiving the first request.

For example, the sending in block 1020 may include sending, by the read-only controller 540 to the second client subsystem 140 via the read-only port 120, results and/or status codes associated with the processed read memory access command.

Further, for example, the sending in block 1020 may be performed in response to the second read-only controller 540 receiving the first request to read first data from the shared namespace 550.

In block 1030 of this optional or additional aspect, the providing in block 820 may further include receiving, from the client subsystem via the second port, a second request to write second data to the shared namespace. For example, in an aspect, the command filtering device (e.g., 110, 210, 335), the read-only controller 540, and/or the command filter component 730 may be configured to or may comprise means for receiving, from the client subsystem 140 via the second read-only port 120, a second request to write second data to the shared namespace 550.

For example, the receiving in block 1030 may include receiving, by the command filtering device (e.g., 110, 210, 335), a write memory access command from the second client subsystem 140 via the read-only port 120. The receiving in block 1030 may further include a determination that the write memory access command was received via the read-only port 120 of the memory storage device (e.g., 110, 210, 310, 410) and that the memory access command is directed to the shared namespace 550 of the memory storage device (e.g., 110, 210, 310, 410).

Further, for example, the receiving in block 1030 may be performed to attempt to initiate a write operation to store data in memory locations comprised by the shared namespace 550.

In block 1040 of this optional or additional aspect, the providing in block 820 may further include filtering out the second request. For example, in an aspect, the command filtering device (e.g., 110, 210, 335), the read-only controller 540, and/or the command filter component 730 may be configured to or may comprise means for filtering out the second request.

For example, the filtering out in block 1040 may include preventing the read-only controller 540 from receiving the second request from the client subsystem 140.

Further, for example, the filtering out in block 1040 may be performed in response to a determination that the write memory access command was received by the command filtering device (e.g., 110, 210, 335) being in a read-only configuration.

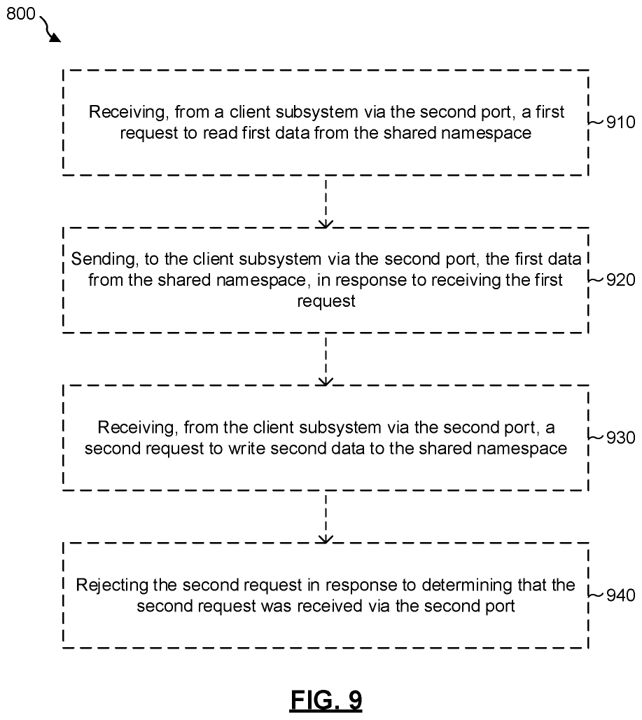

Referring to FIG. 11, in another optional or additional aspect, in block 1110, the method 800 may further include providing, by the device, read and write access to a first namespace of the plurality of namespaces, the first namespace being different than the shared namespace. For example, in an aspect, the command filtering device (e.g., 110, 210, 335), the read-write controller 530, and/or the command filter component 730 may be configured to or may comprise means for providing, by the command filtering device (e.g., 110, 210, 335), read and write access to a first namespace 560 of the plurality of namespaces (e.g., 550, 560A-N), wherein the first namespace 560 is different than the shared namespace 550.

For example, the providing in block 1110 may include the command filtering device (e.g., 110, 210, 335) accepting and/or processing read and write memory access commands for the first namespace 560 received via the read-write port 120 corresponding to the read-write controller 530. For example, the first client subsystem 140, which is communicatively coupled with the read-write port 120 corresponding to the read-write controller 530, may perform read and write operations on data stored by memory locations comprised by the first namespace 560.

Further, for example, the providing in block 1110 may be performed in response to a determination that the memory access command was received via the read-write port 120 of the memory storage device (e.g., 110, 210, 310, 410) and that the memory access command is directed to the first namespace 560 of the memory storage device (e.g., 110, 210, 310, 410).

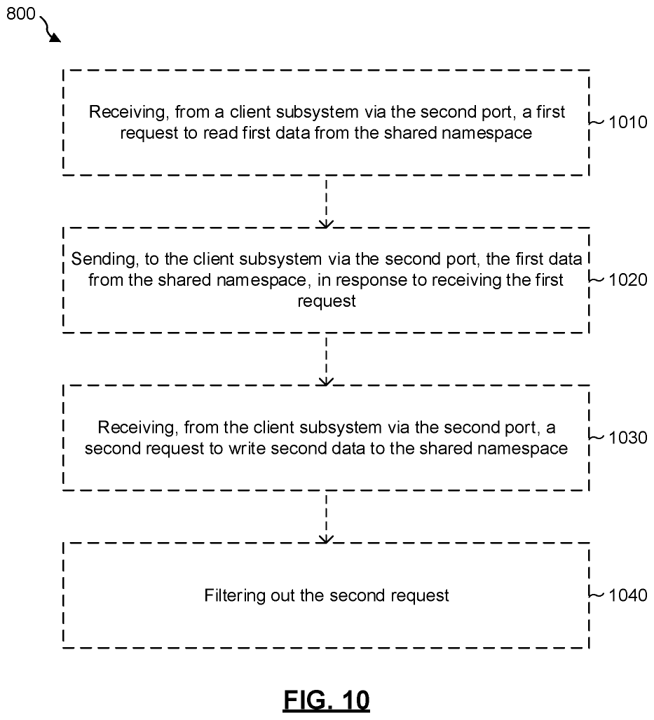

Referring to FIG. 12, in another optional or additional aspect, in block 1210, the method 800 may further include providing, by the device, read and write access to a second namespace of the plurality of namespaces, the second namespace being different than the first namespace, and the second namespace being different than the shared namespace. For example, in an aspect, the command filtering device (e.g., 110, 210, 335), the read-only controller 540, and/or the command filter component 730 may be configured to or may comprise means for providing, by the command filtering device (e.g., 110, 210, 335), read and write access to a second namespace 560 of the plurality of namespaces (e.g., 550, 560A-N), wherein the second namespace 560 is different than the first namespace 560, and wherein the second namespace 560 is different than the shared namespace 550.

For example, the providing in block 1220 may include the command filtering device (e.g., 110, 210, 335) accepting and/or processing read and write memory access commands for the second namespace 560 received via the read-only port 120 corresponding to the read-only controller 540. For example, the second client subsystem 140, which is communicatively coupled with the read-only port 120 corresponding to the read-only controller 540, may perform read and write operations on data stored by memory locations comprised by the second namespace 560.

Further, for example, the providing in block 1220 may be performed in response to a determination that the memory access command was received via the read-only port 120 of the memory storage device (e.g., 110, 210, 310, 410) and that the memory access command is directed to the second namespace 560 of the memory storage device (e.g., 110, 210, 310, 410).

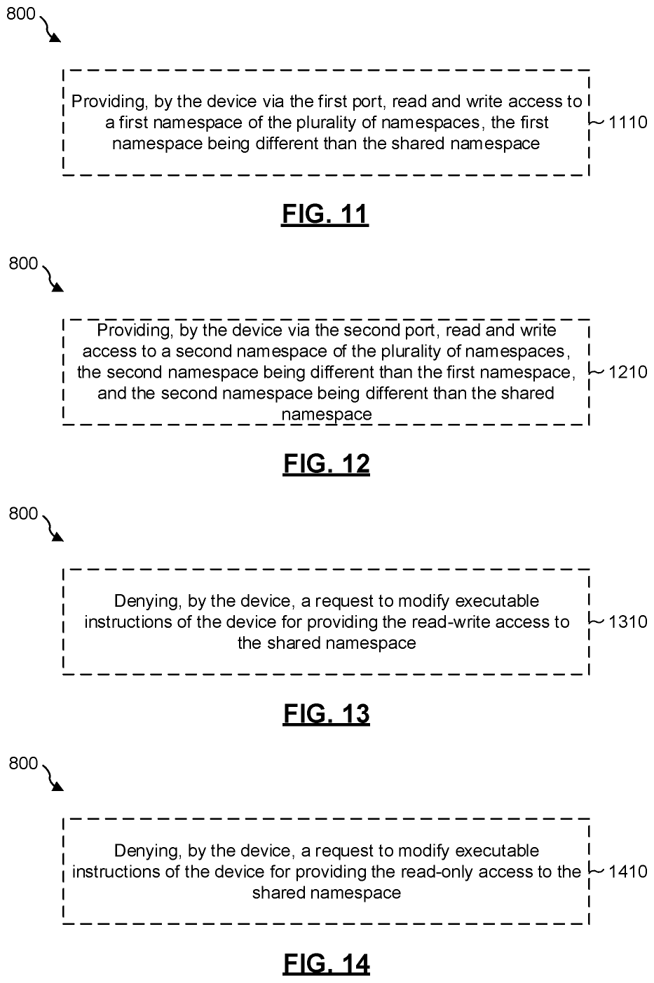

Referring to FIG. 13, in another optional or additional aspect, in block 1310, the method 800 may further include denying, by the device, a request to modify executable instructions of the device for providing the read-write access to the shared namespace. For example, in an aspect, the command filtering device (e.g., 110, 210, 335), the read-write controller 530, and/or the command filter component 730 may be configured to or may comprise means for denying, by the command filtering device (e.g., 110, 210, 335), a request to modify executable instructions of the command filtering device (e.g., 110, 210, 310, 335, 410) for providing the read-write access to the shared namespace 550.

For example, the denying in block 1310 may include denying or preventing additions, deletions, or modifications to the configuration and/or instructions of the command filtering device (e.g., 110, 210, 335), the read-write controller 530, and/or the command filter component 730. The denying in block 1310 may further include continuously monitoring the configuration and/or instructions of the command filtering device (e.g., 110, 210, 335), the read-write controller 530, and/or the command filter component 730 to detect changes.

Further, for example, the denying in block 1310 may be performed to prevent tampering of the memory storage device (e.g., 110, 210, 310, 335, 410).

Referring to FIG. 14, in another optional or additional aspect, in block 1410 of this optional or additional aspect, the method 800 may further include denying, by the device, a request to modify executable instructions of the device for providing the read-only access to the shared namespace. For example, in an aspect, the command filtering device (e.g., 110, 210, 335), the read-only controller 540, and/or the command filter component 730 may be configured to or may comprise means for denying, by the command filtering device (e.g., 110, 210, 335), a request to modify executable instructions of the command filtering device (e.g., 110, 210, 310, 335, 410) for providing the read-only access to the shared namespace 550.

For example, the denying in block 1410 may include preventing the addition, deletion, or modification to the configuration and/or instructions of the command filtering device (e.g., 110, 210, 310, 335, 410), the read-only controller 540, and/or the command filter component 730. The denying in block 1410 may further include continuously monitoring the configuration and/or instructions of the command filtering device (e.g., 110, 210, 310, 335, 410), the read-only controller 540, and/or the command filter component 730 to detect changes.

Further, for example, the denying in block 1410 may be performed to prevent tampering of the command filtering device (e.g., 110, 210, 310, 335, 410).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

What is claimed is:

1. A method, comprising:
providing, by a device via a first port communicatively coupled with a first memory controller, read and write access to a shared namespace of a plurality of namespaces, the first memory controller being communicatively coupled with a non-volatile memory storage comprising the plurality of namespaces; and
providing, by the device via a second port communicatively coupled with a second memory controller, read-only access to the shared namespace, the second memory controller being communicatively coupled with the non-volatile memory storage.

2. The method of claim 1, wherein providing the read-only access to the shared namespace comprises:
receiving, from a client subsystem via the second port, a first request to read first data from the shared namespace;
sending, to the client subsystem via the second port, the first data from the shared namespace, in response to receiving the first request;
receiving, from the client subsystem via the second port, a second request to write second data to the shared namespace; and
rejecting the second request in response to determining that the second request was received via the second port.

3. The method of claim 1, wherein providing the read-only access to the shared namespace comprises:
receiving, from a client subsystem via the second port, a first request to read first data from the shared namespace;
sending, to the client subsystem via the second port, the first data from the shared namespace, in response to receiving the first request;
receiving, from the client subsystem via the second port, a second request to write second data to the shared namespace; and
filtering out the second request.

4. The method of claim 1, further comprising:
providing, by the device via the first port, read and write access to a first namespace of the plurality of namespaces, the first namespace being different than the shared namespace.

5. The method of claim 4, further comprising:
providing, by the device via the second port, read and write access to a second namespace of the plurality of namespaces, the second namespace being different than the first namespace, and the second namespace being different than the shared namespace.

6. The method of claim 1, further comprising:
denying, by the device, a request to modify executable instructions of the device for providing the read-write access to the shared namespace.

7. The method of claim 1, further comprising:
denying, by the device, a request to modify executable instructions of the device for providing the read-only access to the shared namespace.

8. A device, comprising:
a first port, communicatively coupled with a first memory controller, configured to provide read and write access to a shared namespace of a plurality of namespaces, the first memory controller being communicatively coupled with a non-volatile memory storage comprising the plurality of namespaces; and
a second port, communicatively coupled with a second memory controller, configured to provide read-only access to the shared namespace, the second memory controller being communicatively coupled with the non-volatile memory storage.

9. The device of claim 8, wherein providing the read-only access to the shared namespace comprises:
receiving, from a client subsystem via the second port, a first request to read first data from the shared namespace;
sending, to the client subsystem via the second port, the first data from the shared namespace, in response to receiving the first request;
receiving, from the client subsystem via the second port, a second request to write second data to the shared namespace; and
rejecting the second request in response to determining that the second request was received via the second port.

10. The device of claim 8, further comprising:
a command filter configured to filter out write requests directed to the shared namespace; and
wherein providing the read-only access to the shared namespace comprises:
receiving, from a client subsystem via the second port, a first request to read first data from the shared namespace;
sending, to the client subsystem via the second port, the first data from the shared namespace, in response to receiving the first request;
receiving, from the client subsystem via the second port, a second request to write second data to the shared namespace; and
filtering out, by the command filter, the second request.

11. The device of claim 8, wherein the first port is further configured to provide read and write access to a first namespace of the plurality of namespaces, the first namespace being different than the shared namespace.

12. The device of claim 11, wherein the second port is further configured to provide read and write access to a second namespace of the plurality of namespaces, the second namespace being different than the first namespace, and the second namespace being different than the shared namespace.

13. The device of claim 8, wherein the first port is further configured to deny a request to modify executable instructions for providing the read-write access to the shared namespace.

14. The device of claim 8, wherein the second port is further configured to deny a request to modify executable instructions for providing the read-only access to the shared namespace.

15. A system, comprising:
a first client subsystem;
a second client subsystem;
a non-volatile memory storage comprising a plurality of namespaces; and
a device comprising:
a first port, communicatively coupled with a first memory controller and with the first client subsystem, configured to provide, to the first client subsystem, read and write access to a shared namespace of a plurality of namespaces, the first memory controller being communicatively coupled with the non-volatile memory storage; and
a second port, communicatively coupled with a second memory controller and to the second client subsystem, configured to provide, to the second client subsystem, read-only access to the shared namespace, the second memory controller being communicatively coupled with the non-volatile memory storage.

16. The system of claim 15, wherein providing the read-only access to the shared namespace comprises:
receiving, from the second client subsystem via the second port, a first request to read first data from the shared namespace;
sending, to the second client subsystem via the second port, the first data from the shared namespace, in response to receiving the first request;
receiving, from the second client subsystem via the second port, a second request to write second data to the shared namespace; and
rejecting the second request in response to determining that the second request was received via the second port.

17. The system of claim 15, wherein:
the device further comprises a command filter configured to filter out write requests directed to the shared namespace; and
providing the read-only access to the shared namespace comprises:
receiving, from the second client subsystem via the second port, a first request to read first data from the shared namespace;
sending, to the second client subsystem via the second port, the first data from the shared namespace, in response to receiving the first request;
receiving, from the second client subsystem via the second port, a second request to write second data to the shared namespace; and
filtering out, by the command filter, the second request.

18. The system of claim 15, wherein the first port is further configured to provide, to the first client subsystem, read and write access to a first namespace of the plurality of namespaces, the first namespace being different than the shared namespace.

19. The system of claim 18, wherein the second port is further configured to provide, to the second client subsystem, read and write access to a second namespace of the plurality of namespaces, the second namespace being different than the first namespace, and the second namespace being different than the shared namespace.

20. The system of claim 15, wherein:
the first port is further configured to deny a first request to modify first executable instructions for providing the read-write access to the shared namespace; and
the second port is further configured to deny a second request to modify second executable instructions for providing the read-only access to the shared namespace.
